(19) United States
(12) Patent Application Publication
(10) Pub. No.: US 2007/0105079 A1
(43) Pub. Date: May 10, 2007

(54) Methods and apparatus for teaching effective writing

(76) Inventors: Thomas J. O'Toole, Somerville, MA (US); Patrick C. Daly, Waltham, MA (US); Allison Renna, Hingham, MA (US)

Correspondence Address: GOODWIN PROCTER LLP;PATENT ADMINISTRATOR, EXCHANGE PLACE, BOSTON, MA, 02109-2881, US

(21) Appl. No.: 11/582,511

(22) Filed: Oct. 17, 2006

Related U.S. Application Data
(60) Provisional application No. 60/727,790, filed on Oct. 17, 2005.

(51) Int. Cl. G09B 19/00

(52) U.S. Cl. 434/236

(57) ABSTRACT

The present invention relates to a writing system matching colors to criteria, exemplars, and templates to teach effective writing.

### CROSS-REFERENCE TO RELATED APPLICATIONS

This application claims priority to U.S. Provisional Patent Application Ser. No. 60/727,790, filed on Oct. 17, 2005, the disclosure of which is hereby incorporated herein by reference in its entirety.

### FIELD OF THE INVENTION

The present invention relates generally to a writing system that matches colors to criteria, exemplars, and templates. More particularly, the invention relates to using color templates to guide a user through the writing process.

### BACKGROUND

Currently, students are taught how to write using mnemonics, models, and black and white templates. The foregoing methods tend to be ineffective, because they are too simplistic and fail to help students recognize the various components of an effective piece of writing.

It is, therefore, an object of the present invention to provide methods and apparatus for teaching effective writing by focusing students on the various components of an effective piece of writing and the interrelationships therebetween.

### SUMMARY

Generally, the invention relates to methods and apparatus using colors to analyze student writing and colorized templates to plan a written response that matches the color criteria to teach effective student writing. Colors are often used to organize things; however, using colors to analyze student writing is a new and different approach to teaching students effective writing. The use of colors helps students identify various components of an effective piece of writing and learn the interrelationships of the various components.

The ongoing standards-based revolution in education relies on exemplars to score student work. In the past, writing systems have relied on black and white templates; however, no writing process takes this one step further and incorporates colorized templates as a method of teaching of effective writing. Students write better almost instantly, because the colors help them to both isolate the elements that comprise effective written responses, as well as visualize how these colors work together for a total effect.

In one aspect, the invention relates to a method of teaching effective writing. The method includes the steps of matching a specific color to a specific writing element, developing exemplars based on a student response, and using colorized templates to guide the student through the writing process. Specific colors can include, for example, red, orange, yellow, green, and blue. Specific writing elements can include, for example, thesis, transitional words and phrases, language, style, vocabulary, supporting details, and commentary and analysis.

In various embodiments, the method includes matching a plurality of specific colors with a plurality of writing elements, for example, thesis-red, supporting details-green, and commentary and analysis-blue. The exemplars are developed to train the students to identify examples of effective and ineffective writing. Use of the exemplars also helps to teach the students to use the colorized templates. In one embodiment, the students study the pre-colored exemplars and then color black and white exemplars to identify various writing elements. The colorized templates are used to help students at least one of plan, assess, and/or revise their writing. The colors described herein are by way of example only, as other colors may be used as long as the students and teacher use the same colors.

In another aspect, the invention relates to colorized templates for guiding a user through the writing process. The colorized templates will vary to suit a particular type of writing, such as, for example, compositions and essays. A template in accordance with the invention includes a first user prompt having a first color corresponding to a first writing element (for example, a red thesis prompt), and at least one second user prompt of a second color corresponding to a second writing element (for example, a plurality of green supporting detail prompts). The second writing element typically builds off of the first writing element. In the examples given, the second writing elements are the supporting details for the proposition stated in the thesis.

In various embodiments, the templates can include multiple different writing elements that branch off from one another. The templates can be used to brainstorm an argument, prioritize arguments, and link the various arguments, for example. The completed templates constitute the pre-writing portion of creating the final written product. Once the template(s) are complete, the user then transfers the text from the templates into the written product.

In another aspect, the invention relates to teaching kits. The kits can include customized highlighters identified by their corresponding writing element. Customized highlighters can be desirable for consistency, in particular during the learning process. The kits can also include workbooks including instructions and various templates. In one embodiment, the workbook includes sets of colorized and black and white exemplars and corresponding colorized templates matched to the particular type of writing to be completed.+

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

This patent or application contains at least one drawing executed in color. Copies of this patent or patent application publication with color drawing(s) will be provided by the U.S. Patent and Trademark Office upon request and payment of the necessary fee. In the drawings, like reference characters generally refer to the same parts throughout the different views. In addition, the drawings are not necessarily to scale, emphasis instead generally being placed upon illustrating the principles of the invention. In the following description, various embodiments of the present invention are described with reference to the following drawings, in which:

FIG. 1 is a pictorial representation of a first step of a long composition planning template in accordance with one embodiment of the invention;

FIG. 2 is a pictorial representation of a second step of the long composition planning template of FIG. 1;

FIG. 3 is a pictorial representation of an alternative second step of a long composition planning template in accordance with one embodiment of the invention;

FIG. 4 is a pictorial representation of a third step of the long composition planning template of FIG. 1;

FIG. 5 is a pictorial representation of one example of a color criteria system in accordance with one embodiment of the invention;

FIG. 6 is a pictorial representation of an alternative template in accordance with one embodiment of the invention;

FIGS. 7A-7Z depict various aspects of the teaching method in accordance with one embodiment of the invention; and

FIG. 8 is a pictorial representation of a kit in accordance with one embodiment of the invention.

### DETAILED DESCRIPTION

Embodiments of the present invention are described below. It is, however, expressly noted that the present invention is not limited to these embodiments, but rather the intention is that variations, modifications, and equivalents that are apparent to the person skilled in the art are also included. Additionally, the descriptions of various colors and corresponding criteria are given by way of example only, and the colors and corresponding criteria may vary to suit a particular application or writing element.

In one example, the method is embodied in a color criteria system teaching effective writing. The system is effective for various types of writing, for example, descriptive/creative, expository, persuasive, and narrative. The system is particular useful for teaching students literary analysis as may be found, for example, in standardized tests that students are required to pass in order to graduate.

In the system, students study exemplars and use colored highlighters to learn how each sentence within a composition matches, for example, to the following criteria:

thesis/topic/focus (red), commentary and analysis (blue), supporting details (green), transitional words and phrases (orange), and language and style (yellow). See FIG. 5. As shown in FIG. 5, effective writing is typically divided into five different criteria. Teachers use these different colors as part of classroom writing instruction. A teacher will begin a composition by writing each sentence according to the various colors as shown in FIG. 5. After studying exemplars, students colorize their own writing to analyze it for the same elements. Teachers then will use colorized templates to help students further plan their written responses as well as use colors to help students revise their written responses. This process is a cognitive process in which students realize the essential elements of an effective composition both by direct observation (exemplars), by practice (highlighters) and by planning templates. Once trained, students can also readily identify elements that are missing from writing that is below the standard.

By using colors to highlight an essay, students will be able to deconstruct the essay and better understand its components. In one aspect, the color system is similar to a mnemonic device and, therefore, students and teachers should adhere to the exact same colors in order to achieve the proper result; for example,
Red=thesis/topic (the life blood of the essay) 1,
Orange=transitions 3,
Green=support and details from the text 5,
Blue=commentary and analysis/your thoughts and opinions 7, and
Yellow=the colorful sentence 9. See FIG. 5.

The method of deconstructing the essay is the use of a colorized mnemonic system that assigns specific colors to the specific elements of a quality essay. On the surface this system may seem simple, but in reality it is a complex method that needs to be integrated with the other approaches to teaching writing. It is not enough to colorize an essay, what is truly happening is the students are recognizing the elements that a quality essay includes and will help them discover what it is that their essay requires.

It is essential that once the colors are given a designated topic that they remain associated with that color, or the system may fail. It is helpful if the students are using this organized, unified, color system across the curriculum. Once someone breaks the form and assigns orange to thesis instead of transitions, the system may break down. By colorizing the elements present in every sentence, students will begin to understand the role of every section of a sentence, and then further understand the purpose of every sentence within the composition.

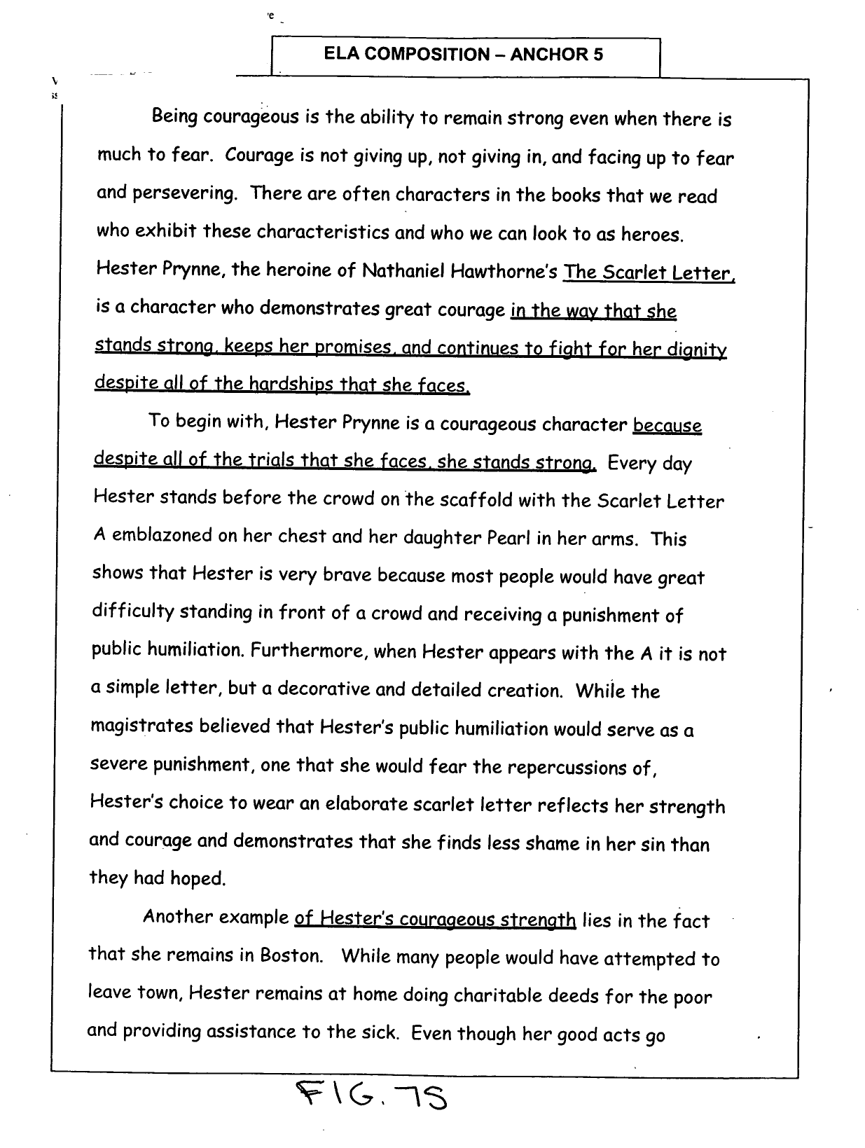

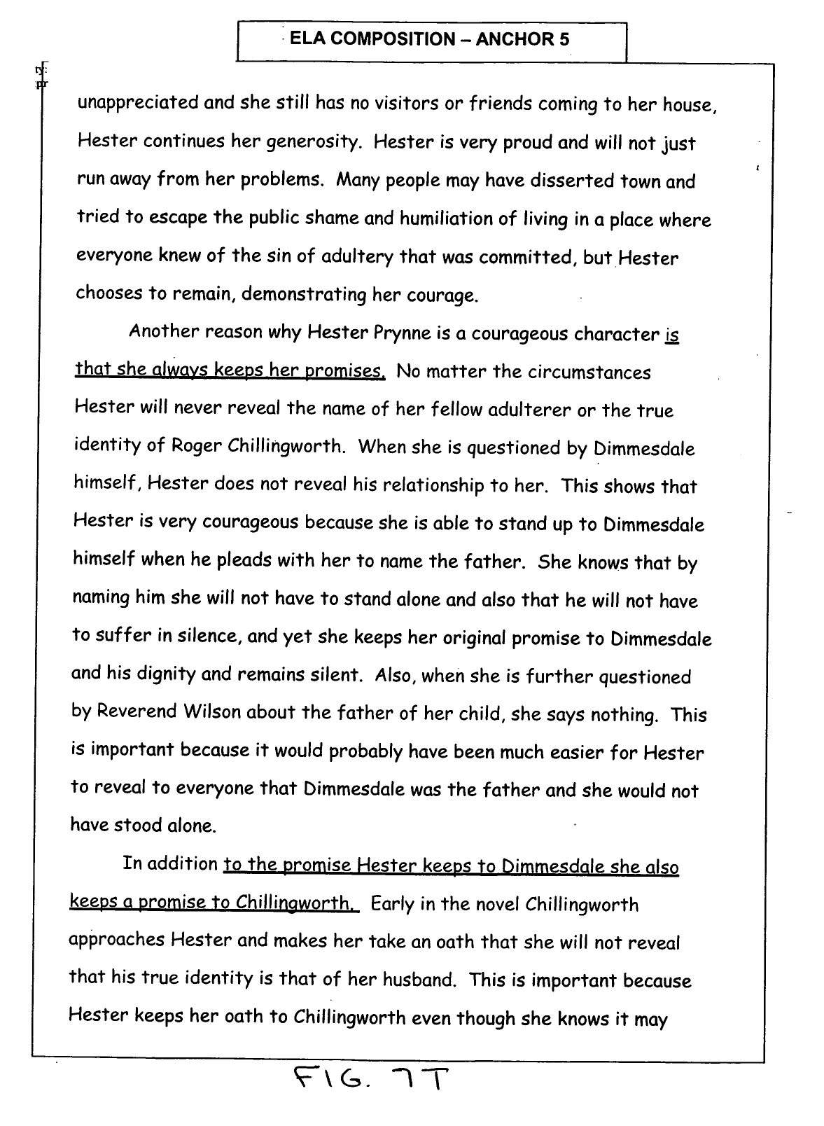

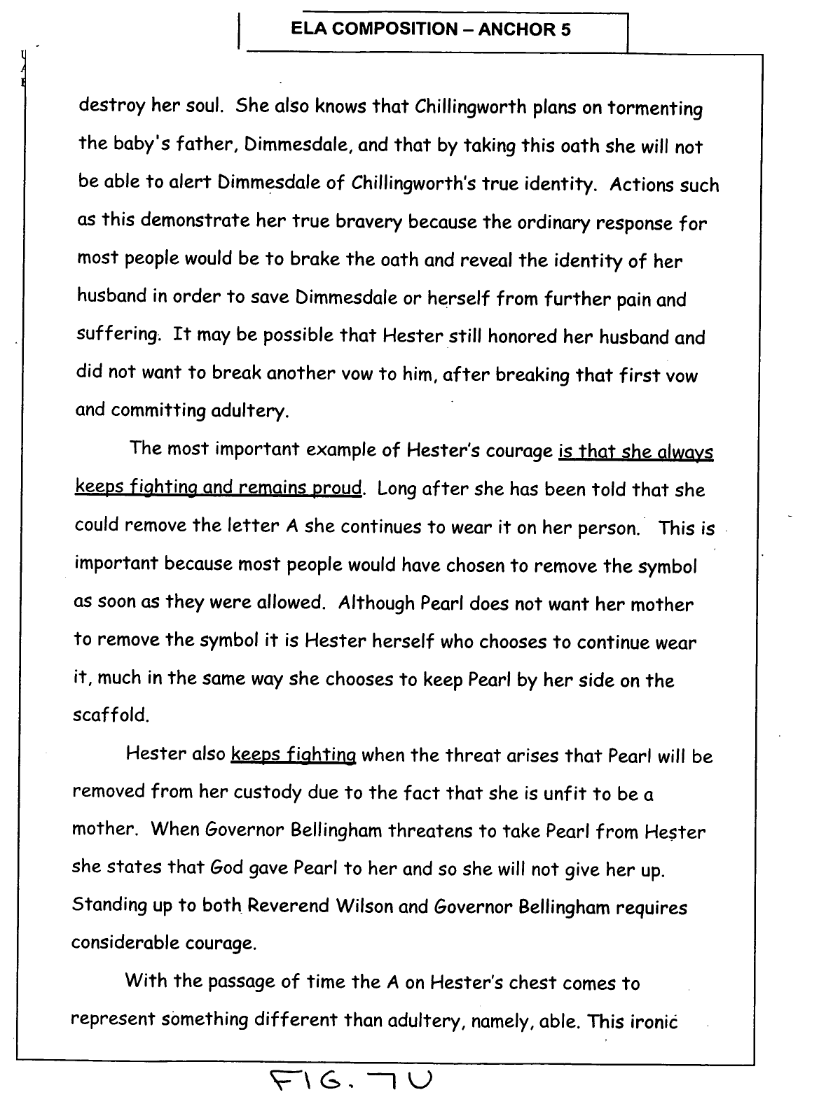

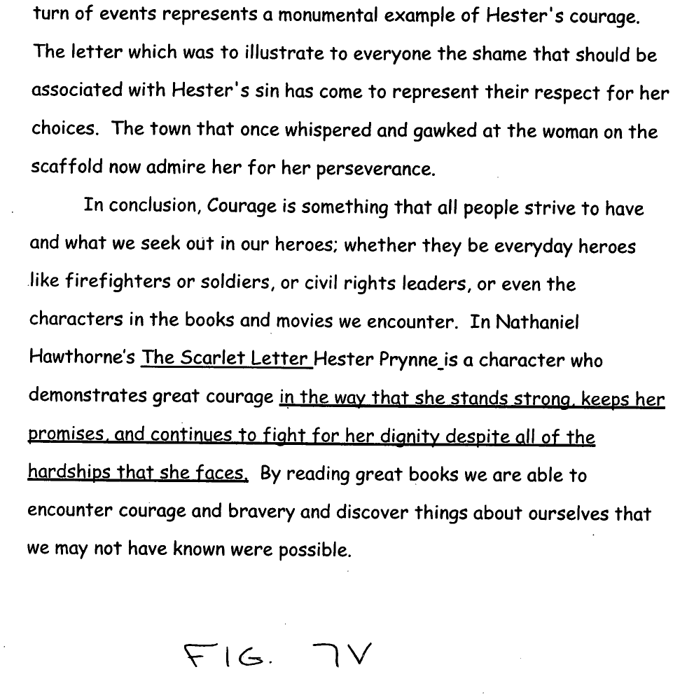

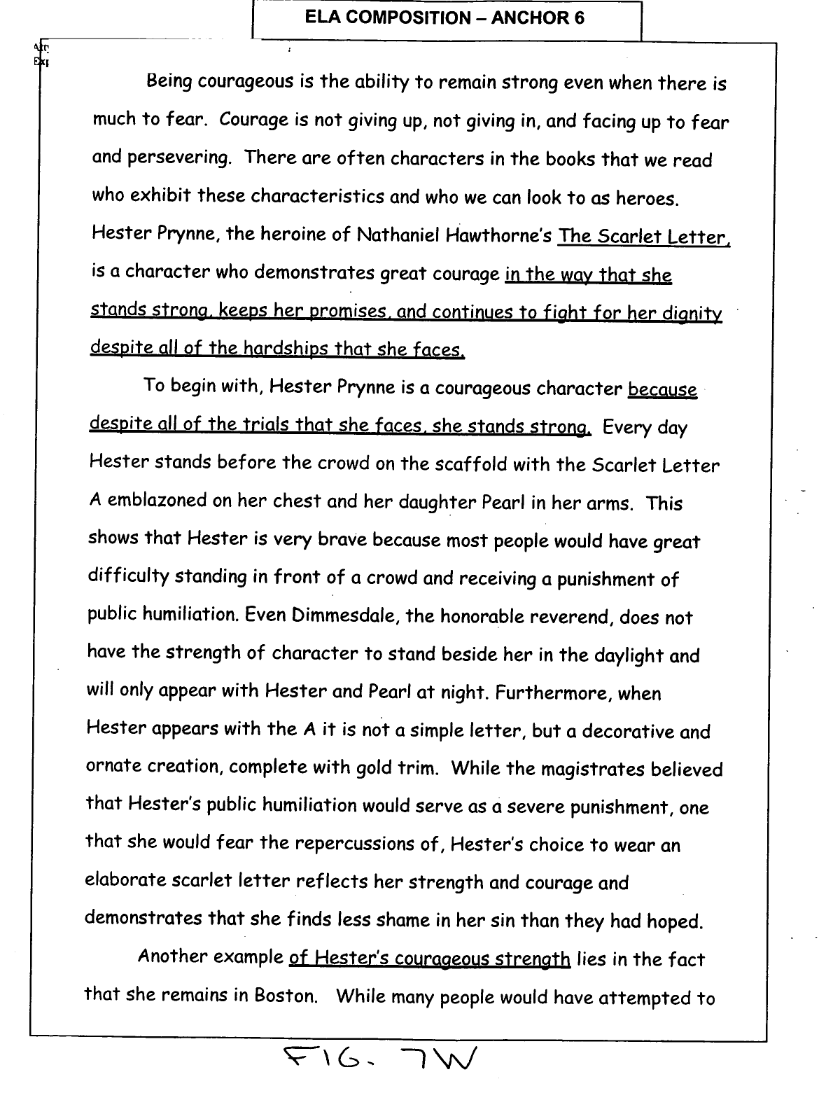

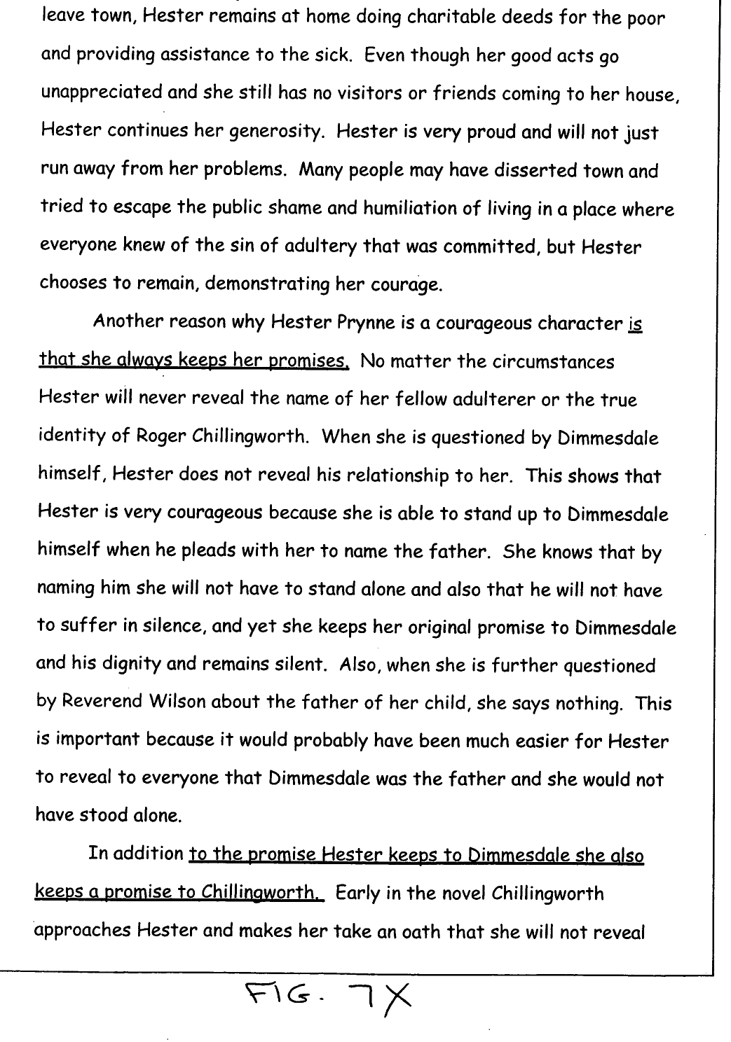

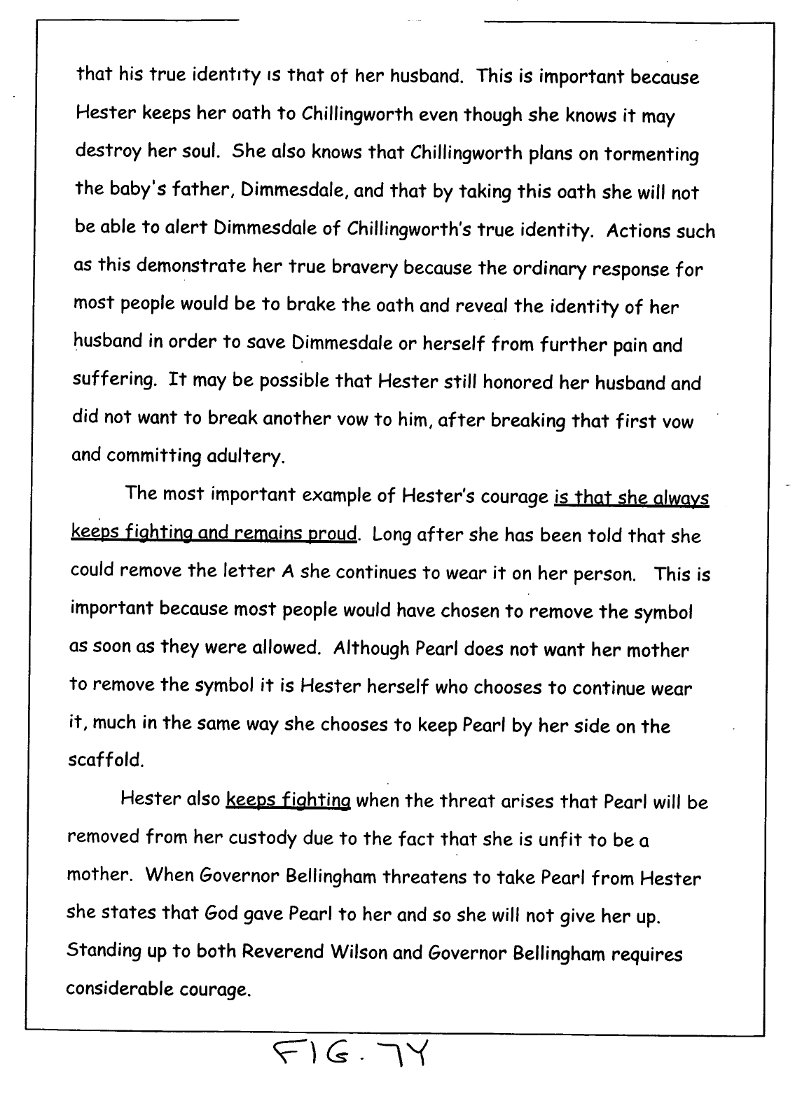

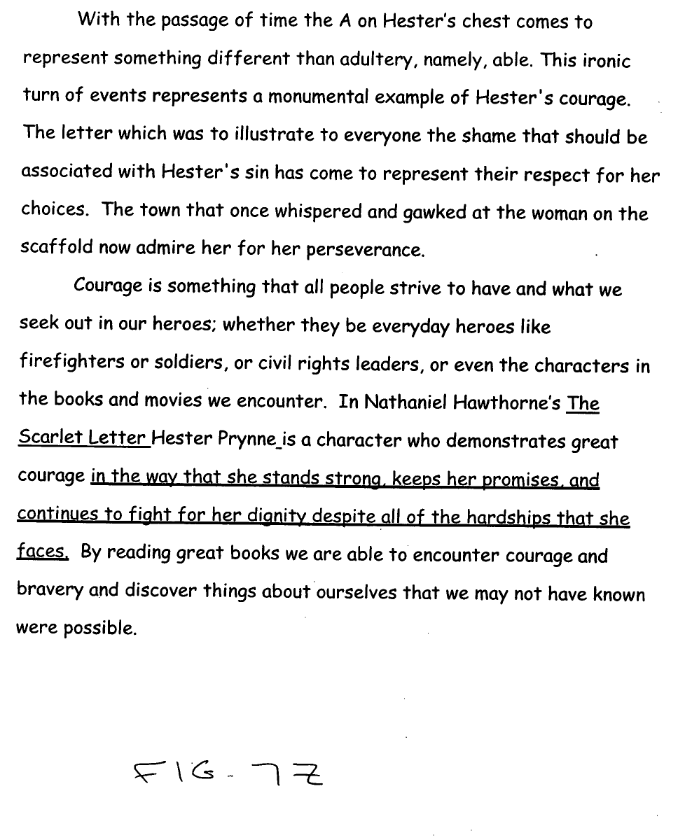

The color system involves much more than assigning colors to certain sentences, it is a cognitive process in which students realize the essential components of a quality essay. Students will recognize what is present in good essays and what is deficient in lesser pieces of writing. Students will colorize exemplars and learn the colorizing process, as well as develop other checklists and mnemonics that will assist them in creating and editing their writing. One example of the teaching method is represented by FIGS. 7A-7Z, where the example is geared to a grade 10 English language arts composition using The Scarlet Letter as an example.

FIG. 7A depicts the question or prompt 20 presented to the student in an examination or training exercise. FIGS. 7B-7J depict the steps a student should follow to begin to create their web template (graphical organizer) 22 and develop a response to the prompt 20. Specifically, FIG. 7C depicts the first element (RED) 24 of the web template 22. The RED represents primarily the THESIS of the composition, and subsequently the topic sentences of the body paragraphs, which relate to the thesis. Red will represent the “life blood” of the essay and should, therefore, be present throughout. If a student repeats the thesis in her topic sentences she leads herself to develop a well-organized essay and avoids the pitfalls of running off-course with her essay, which will be evident to the student by seeing the colors throughout the written work product. FIG. 7D depicts the addition of the supporting details (GREEN) 26 added to the web template 22. The GREEN represents the RELEVANT DETAILS of the argument. The support should be textual and factual. Details should be relevant to the topic at hand (an organization skill decided during the outlining and the webbing process). In FIG. 7E, the supporting details 26 are linked to particular topics 28, which are added to the template 22 and arranged in order. Additional supporting details 26 are added to the web template 22 in FIG. 7F. Only a portion of the template 22 is shown in FIGS. 7F, 7G, and 7H. Commentary and analysis components (BLUE) 30 are added to the template 22 to further support the thesis 24 in FIG. 7G. The color BLUE represents the students own COMMENTARY and ANALYSIS or THOUGHTS and FEELINGS. The student should express her own opinions and commentary on the details she has provided. BLUE sentences should not merely repeat the information of the GREEN sentences, but investigate their meaning. These sentences often begin with the words THIS MEANS THAT or THIS SHOWS THAT. In FIG. 7H, transitional phrases (ORANGE) 32 are added to the template 22 to further organize the student's response to the prompt 20. FIG. 7J depicts the completed web 22 created by a student practicing the method of the invention and using a colored web template 22. Once the template 22 is completed, the student can transfer the various elements of the template 22 into written work product in response to the prompt 20. See FIG. 6 for an example of a colored template arranged in paragraph form, which can be used alone or in conjunction with the web template to assist the student in organizing their written work product.

FIGS. 7K to 7Z depict various examples of written responses to the prompt 20 as may be developed with the method of the invention. The anchors are identified as anchor 1 (FIG. 7K), anchor 2 (FIG. 7L), anchor 3 (FIG. 7M), anchor 4 (FIGS. 7N and 70), anchor 4a (FIGS. 7P-7R), anchor 5 (FIGS. 7S-7V), and anchor 6 (FIGS. 7W-7Z), which correspond to the quality of the written work product, where anchor 1 is the lowest quality and anchor 6 is the highest quality. By fully utilizing the method and template, the student will be able to produce a higher quality written response.

In addition, these anchors can be used as colorized exemplars to illustrate to the student the difference between the varying qualities of responses. The colorized exemplars enable the student to see what writing elements are present or missing from responses of varying quality. Once the student has practiced with the colorized exemplars, the student should be able to colorize black and white exemplars to further develop their understanding the various writing elements that go into a quality written work product.

When colorizing the anchor 1 essay, students will recognize the abundance of GREEN, which represents the details of the story. If the details are not relevant to the argument of the composition, then a GREEN BOX is used to illustrate that those details are not germane to this argument. In the anchor 1 essay, the student often strays from any good mechanical structure, the RED thesis and topic sentences are not present, ORANGE transitions are not placed throughout the essay, and most of all, there is hardly any relevant BLUE commentary and analysis from the student.

Beginning with the anchor 1 essay and moving toward the anchor 6 essay students see the emergence of the 5-4-3-2-1 elements (see hereinbelow), as well as a progression of colors as the essays develop. Without reading a single word, students can notice the impact of the colors. As students decide which colors to use, they begin to realize that some essays are missing colors. In the lower essay, students often note the lack of blue, which leads to an essay that reads more like a book report than an argument or an analysis.

What students are actually doing is deconstructing the anchors and examining the functions of each sentence and how those sentences lend themselves to the overall organization of the argument. After a few group anchors, students can begin to move along on their own and identify the colors. In certain instances there will also be some debate as to which colors to use, as some more complex sentences may involve more than one color.

Standardized versions of the aforementioned templates can be supplied in a workbook for use by teachers and students including black and white samples that the student colorizes as an exercise to identify the various elements of writing. The colorization exercise allows the students identify and differentiate between writing of varying quality.

Understanding the core elements of a quality composition is an important aspect of writing that the students must embrace. A deconstruction of what is working in the foundation of a quality essay is essential to the student in order for her to begin constructing her own composition. By using the templates of the present invention, little memorization is required and the students can rely on one mnemonic. If the student's essay includes the elements include in this mnemonic she will have written a quality essay. This mnemonic can be used during the pre-writing process, but may be most useful during the editing stage of writing.

The editing session has been used by many students as little more than a proofreading session wherein the students reread and circle spelling and grammatical errors, without any consideration of organization, form, and structure. The 5-4-3-2-1 mnemonic will allow them to recall this checklist for the proper elements of a quality essay. The 5-4-3-2-1 mnemonic template is as follows:

5—paragraphs (introduction, body 1, body 2, body 3, conclusion), at least 4—transitions,

3—body paragraphs (1=good argument, 2=better, 3=best), at least 2—supports/examples per body paragraph (content and analysis), and

1—thesis/focus/title.

Another mnemonic that can be used with the color teaching method to help the student develop a response to the prompt is as follows:

Q—quotes

U—understand the prompt

I—invert the prompt

E—explain the quotes (“this means . . . ”)

T—transitions within the body from one example to the next

E—examples @ least 3)

R—restate the inverted prompt

Quotations can be anything from individual words to whole passages used to support your argument. Single words can be used to demonstrate tone or theme, and longer passages will prove that your idea is supported by the text—better than paraphrasing or summarizing. As long as you are sure to quote directly and accurately, you will improve your open response (OR) answer.

Understanding the prompt is one of the keys to being successful on the OR. So many students lose points because they do not fully recognize that there may be multiple questions asked within the prompt. Make sure to fully understand the question before proceeding to the Prewriting/Graphic Organization stage.

Inverting the prompt is key in the OR answer. Although it may sound simplistic, it gets right to the point of the question. An OR answer is an extended short answer. It is not a long composition, and therefore, the thesis of the piece comes at the beginning (rather than at the end of the introduction as in a long composition). It is good to practice inverting several prompts (just one sentence each) in order to be fluent in this style of writing.

Explanations of your quotations are vital to a successful answer on the OR. This is where you support your argument with your own thoughts. It is NOT enough to “drop” quotations into a paper without any reasoning behind them. You must write a few sentences that support those quotes and Explain why they are central to your argument.

Transitions should be used throughout the body of the answer whenever you move from one idea to the next. Transitions alert the reader to a progression in your argument. You should have a pool of transition words in mind that you use when writing all of your OR answers. By including transitions you force yourself to move on to new topics and do not dwell on one point. i.e. If you use “to begin with,” “another example,” and “the most important reason” you have set yourself up to continue with three distinct arguments.

Examples can be your quotations—or also any other references to the text. It is essential that you give at least 3 examples to support your text. If the prompt asks you to support two separate points (i.e. discuss how the passage relates both an internal and external conflict) you must give examples and at least one quotation for each point, both internal and external.

Restate the inverted prompt in one or two sentences as a conclusion. This proves to your reader that you have made your point and kept your focus. Use transitions such as, “in short,” or “in conclusion,” to emphasize that you are closing your arguments tightly.

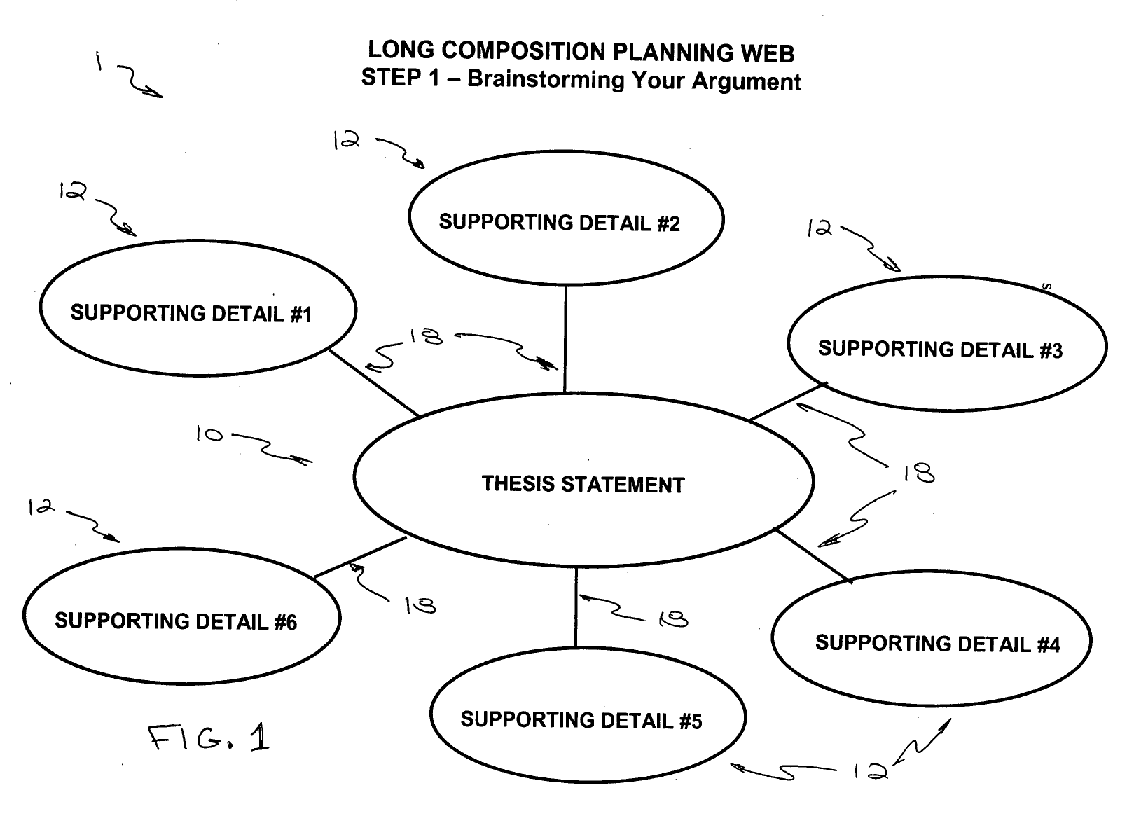

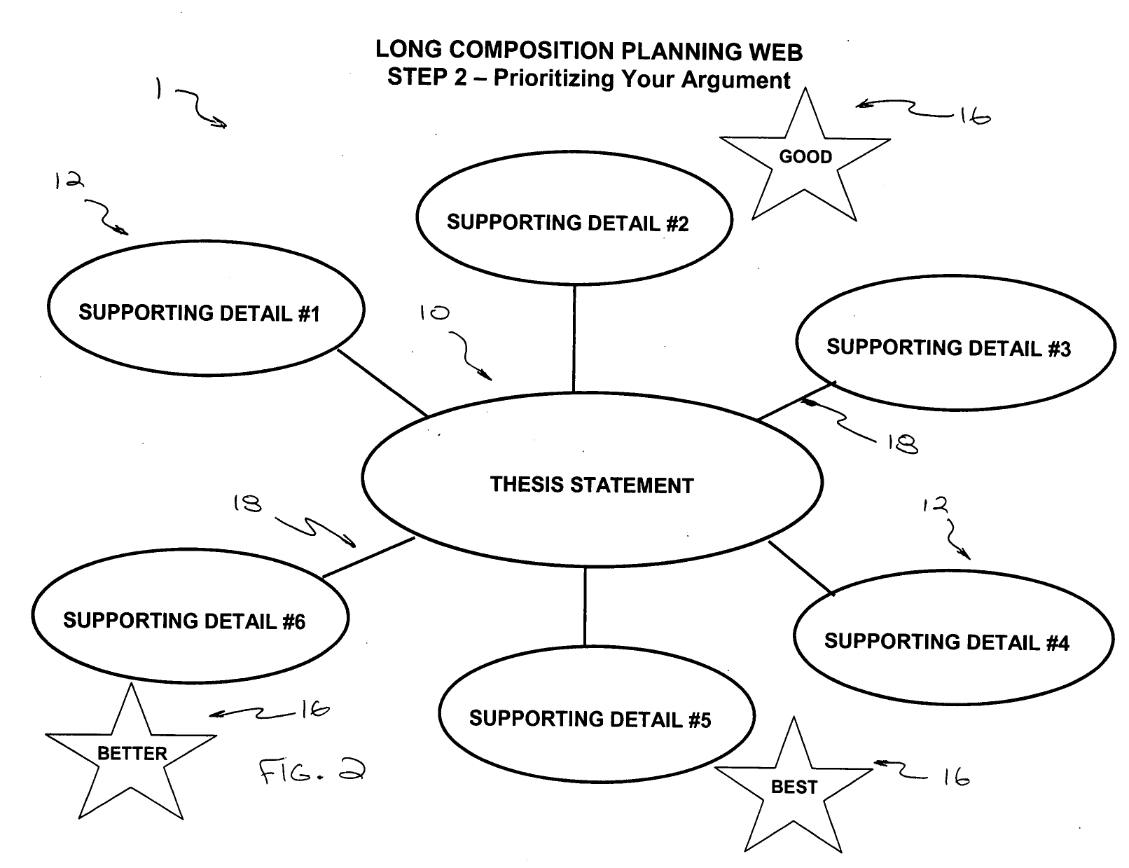

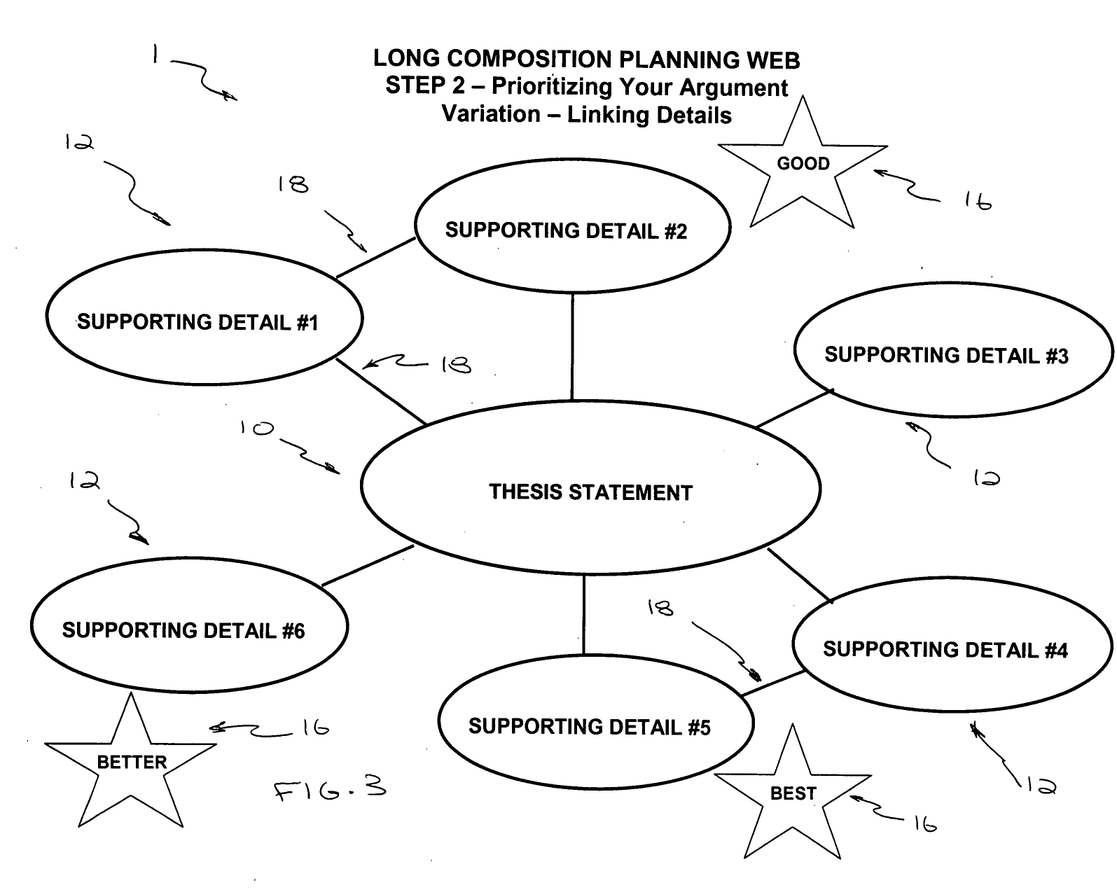

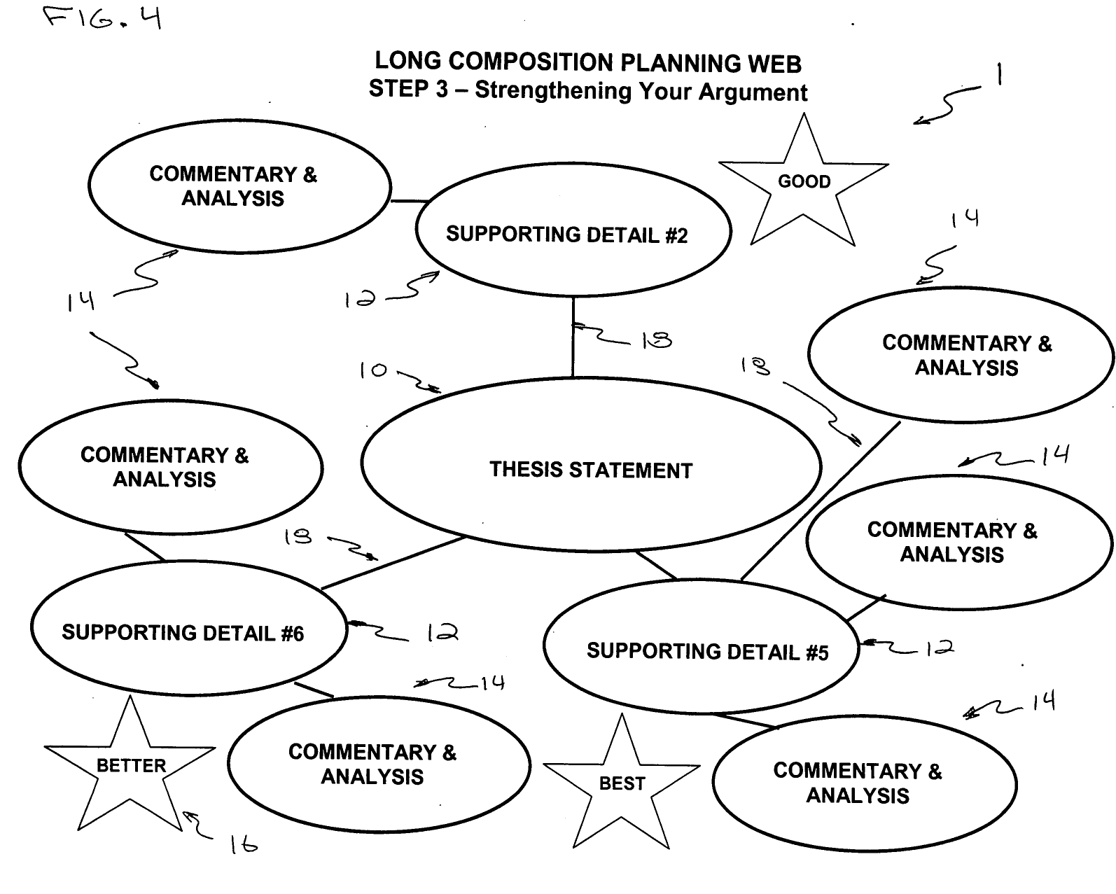

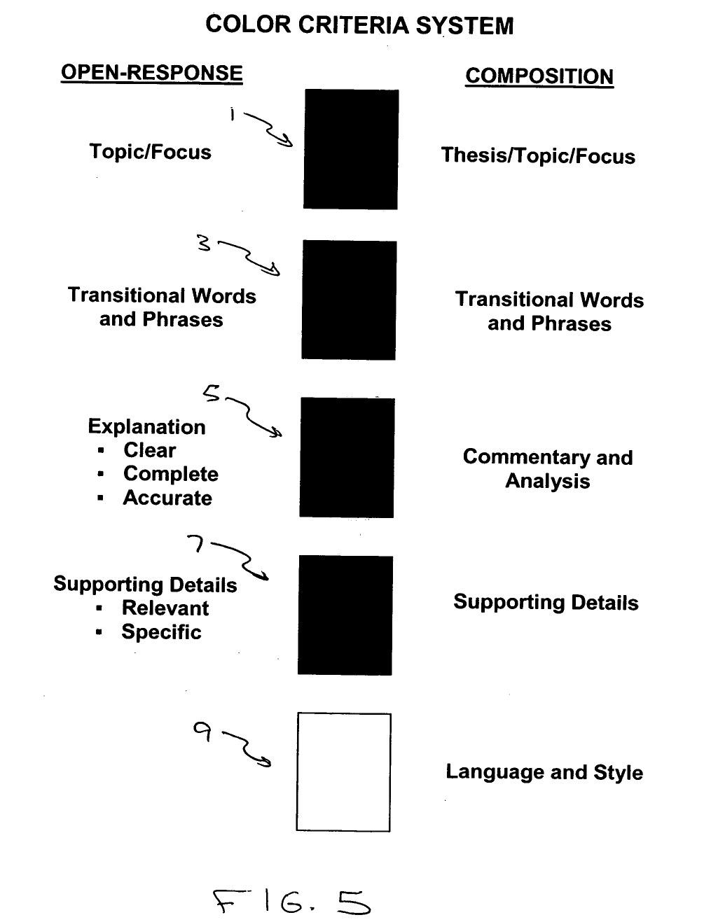

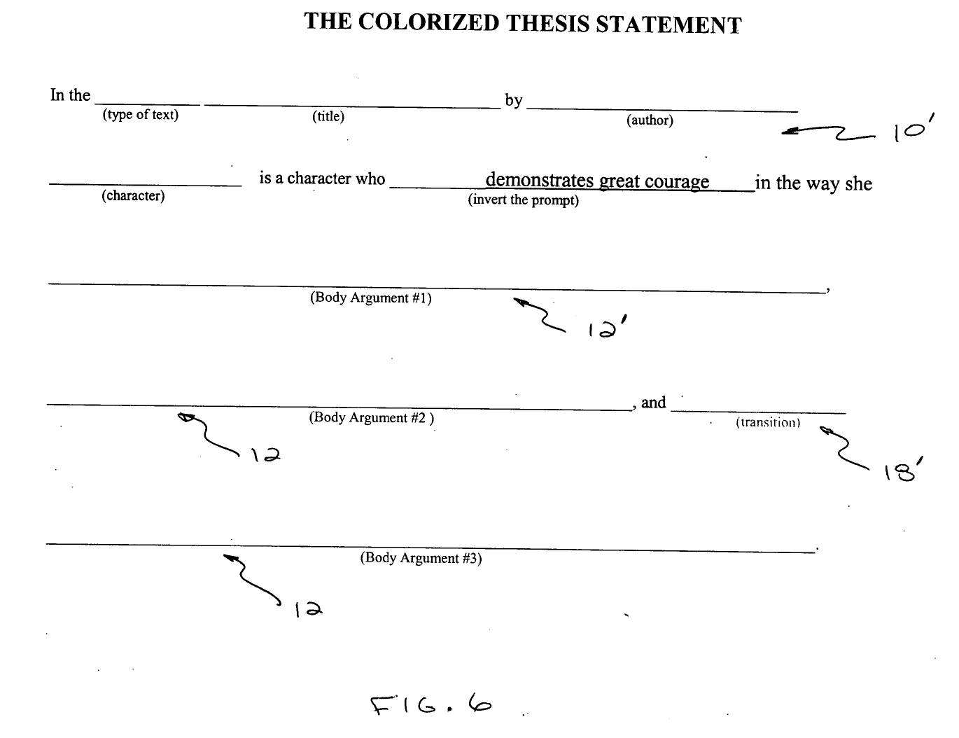

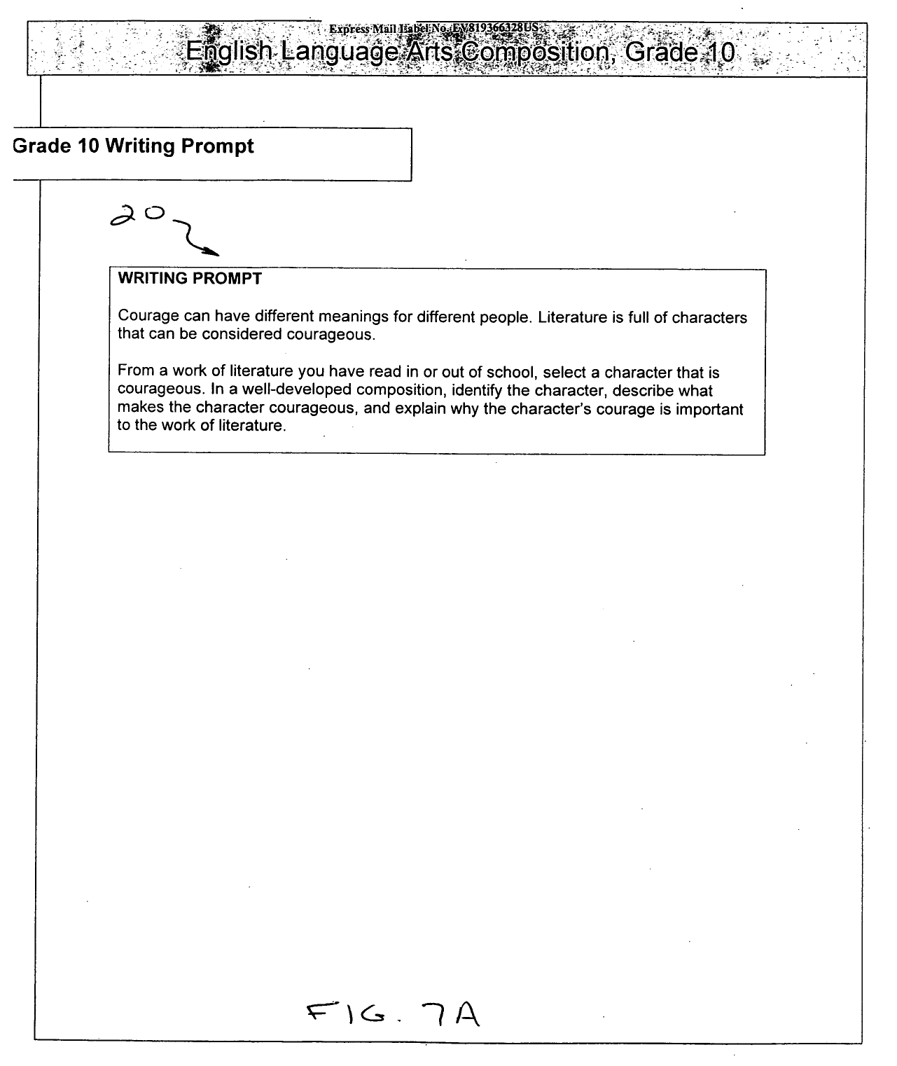

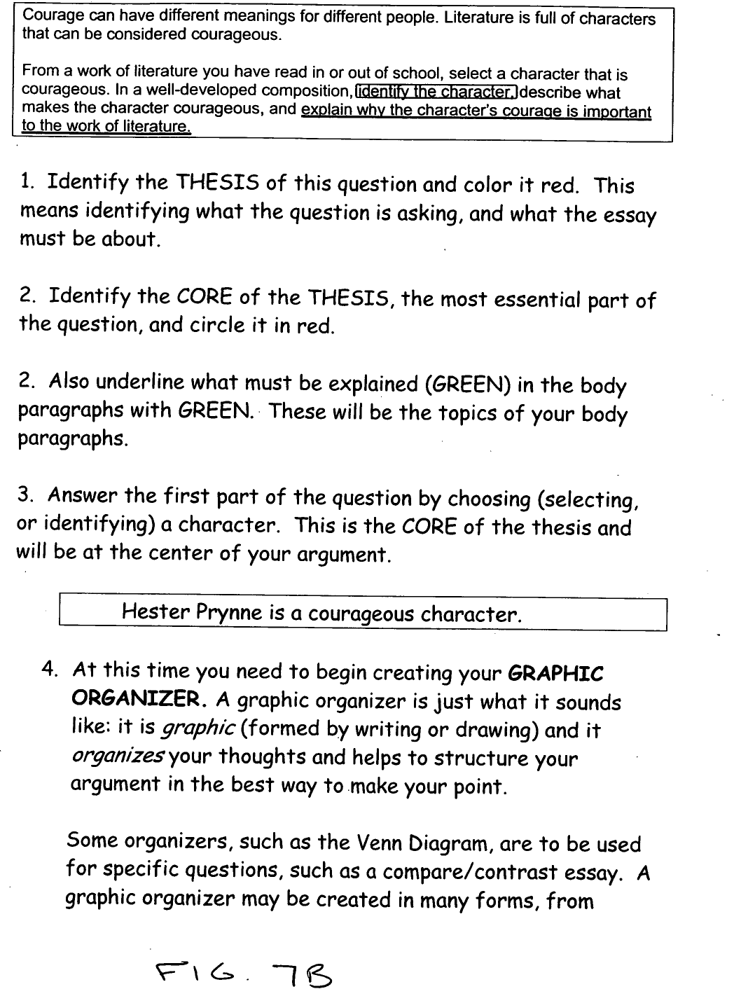

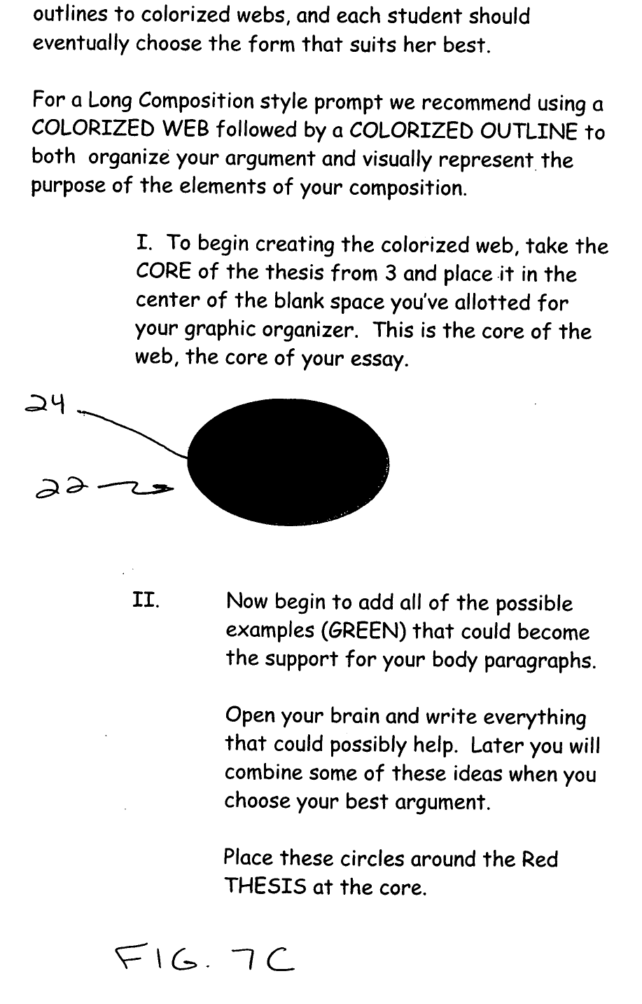

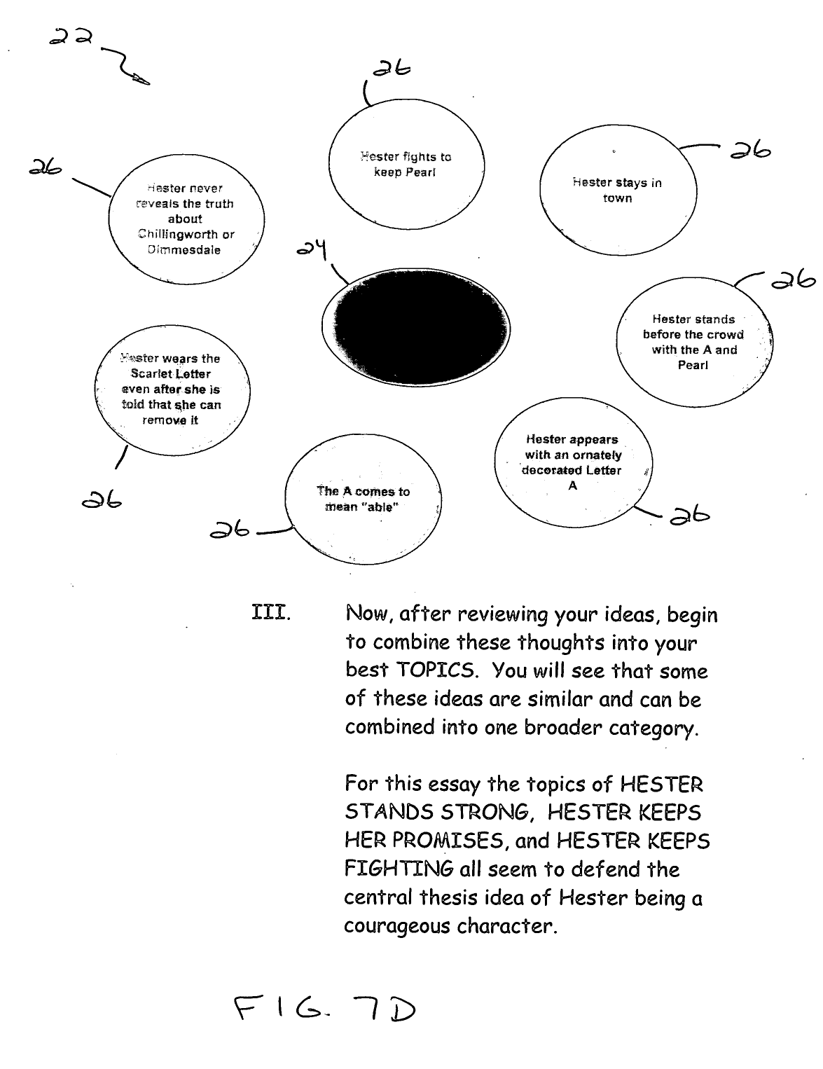

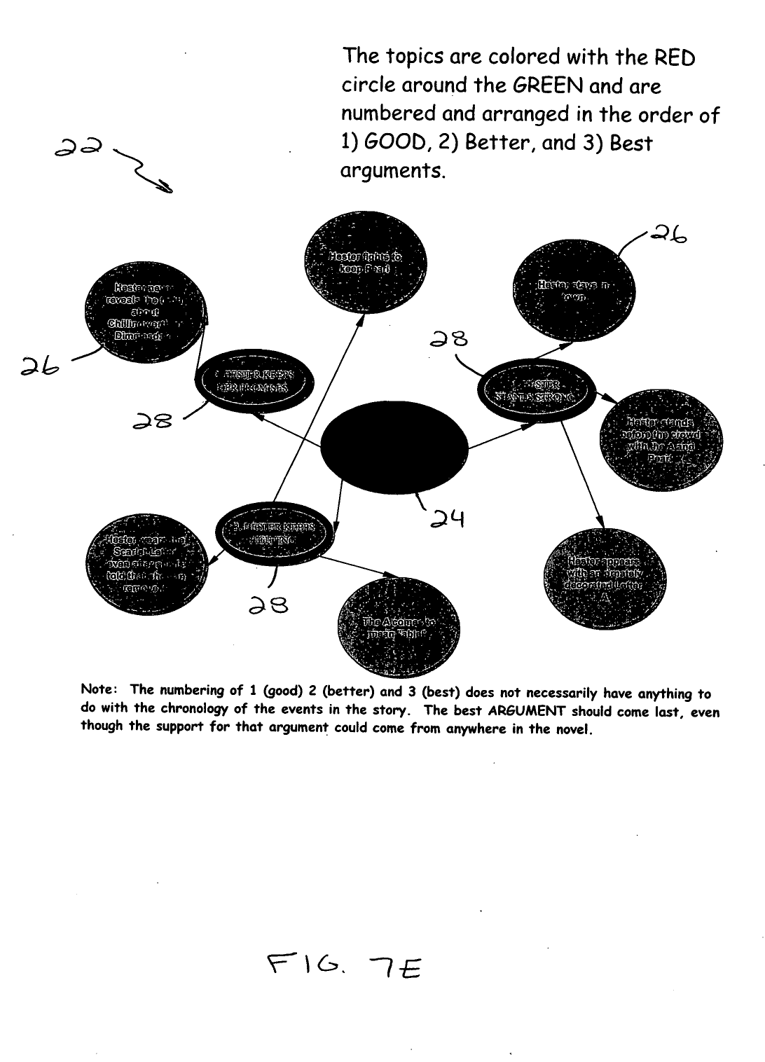

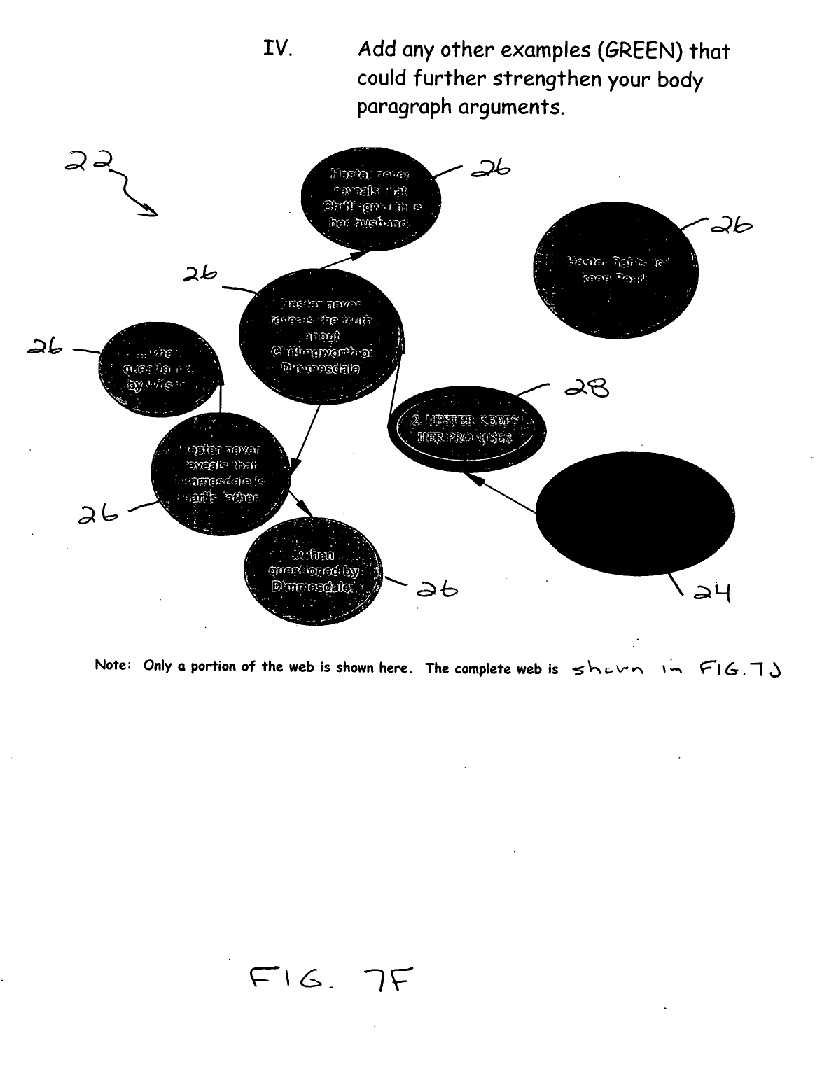

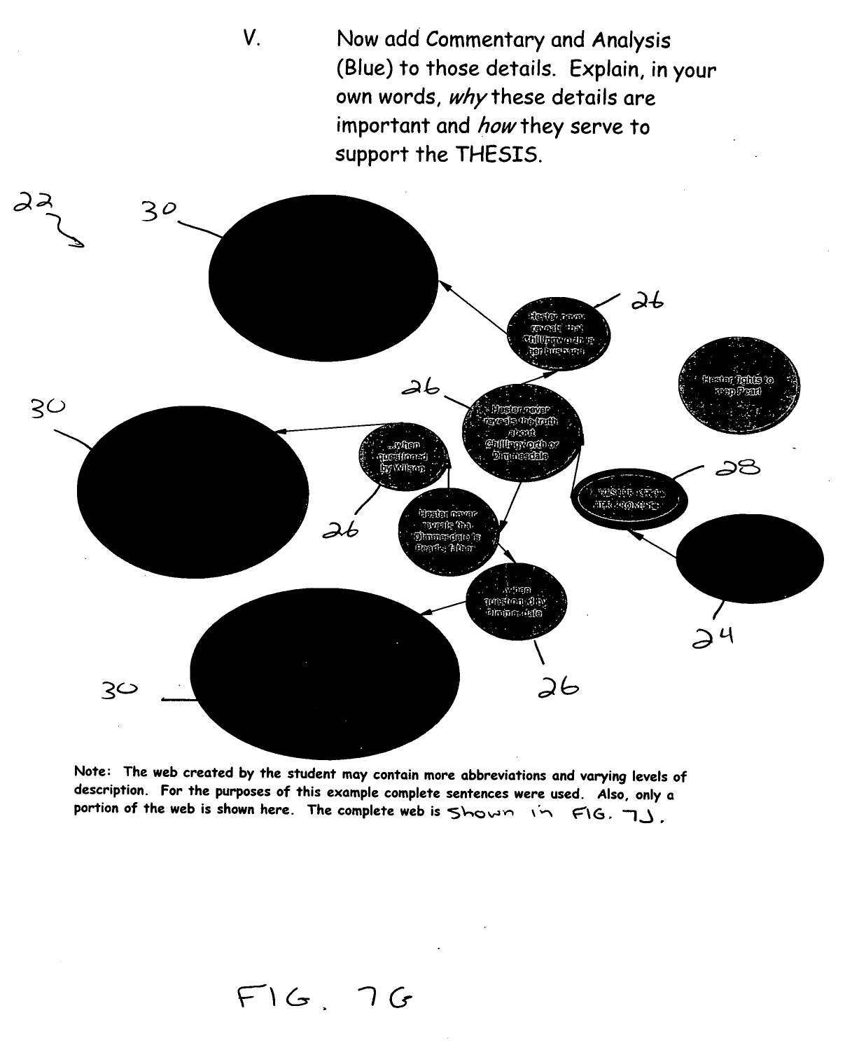

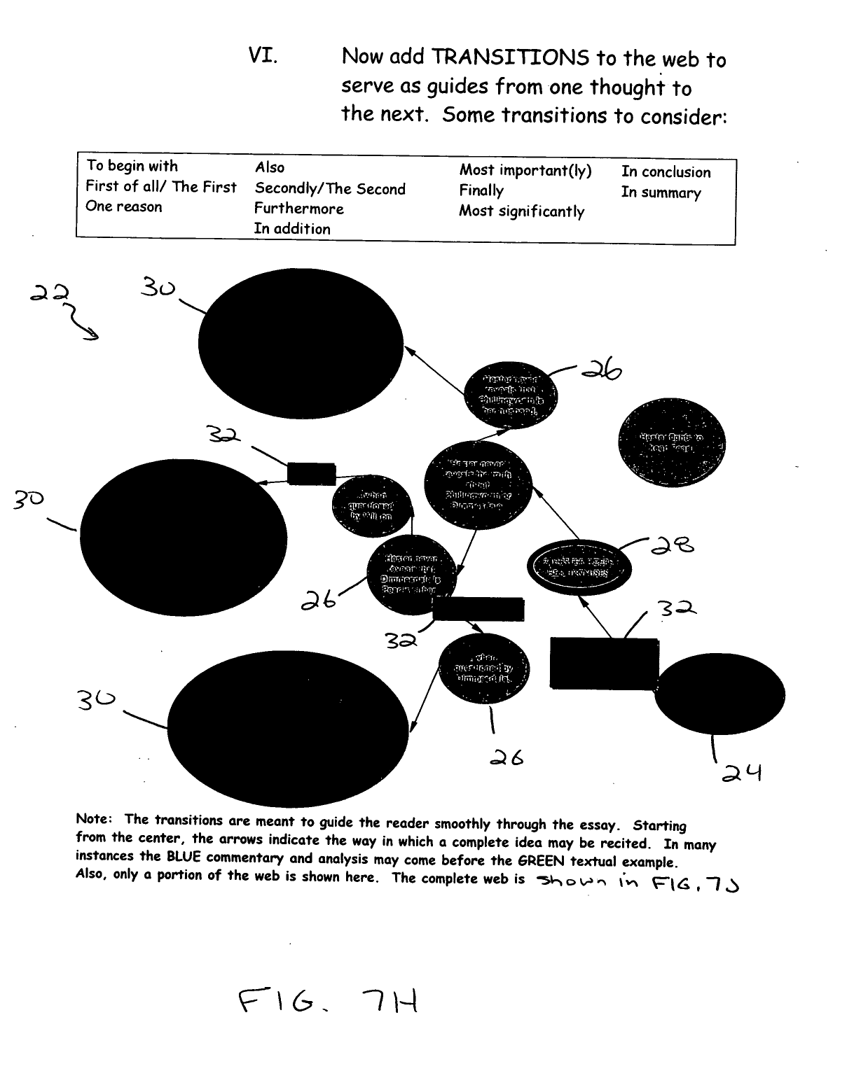

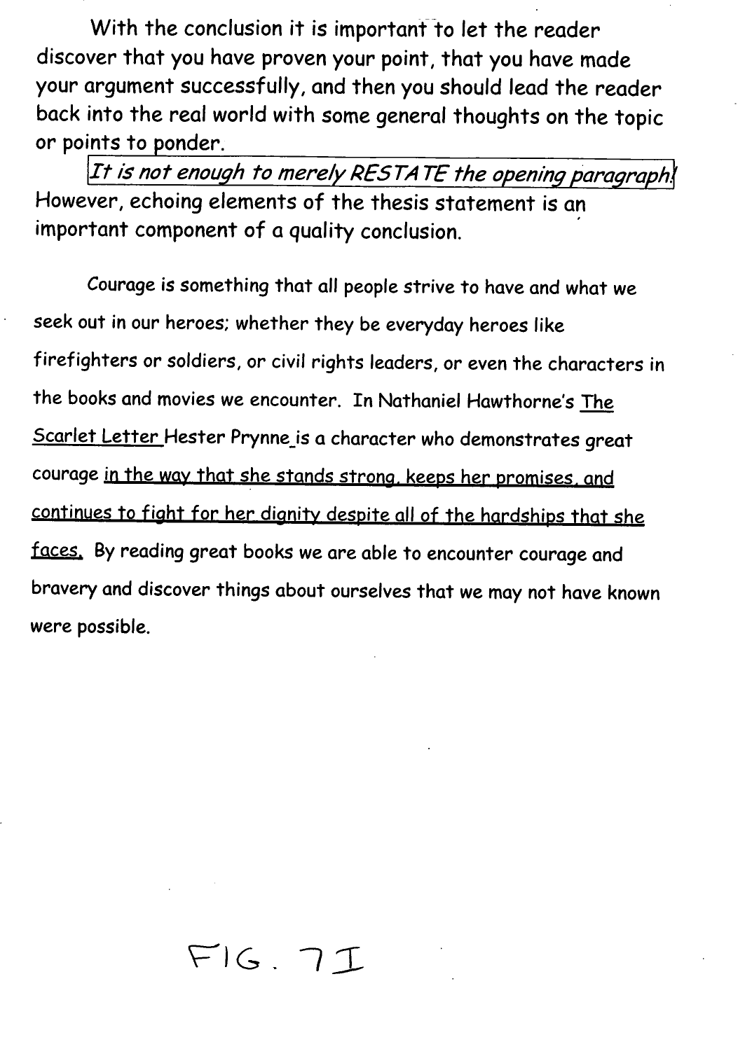

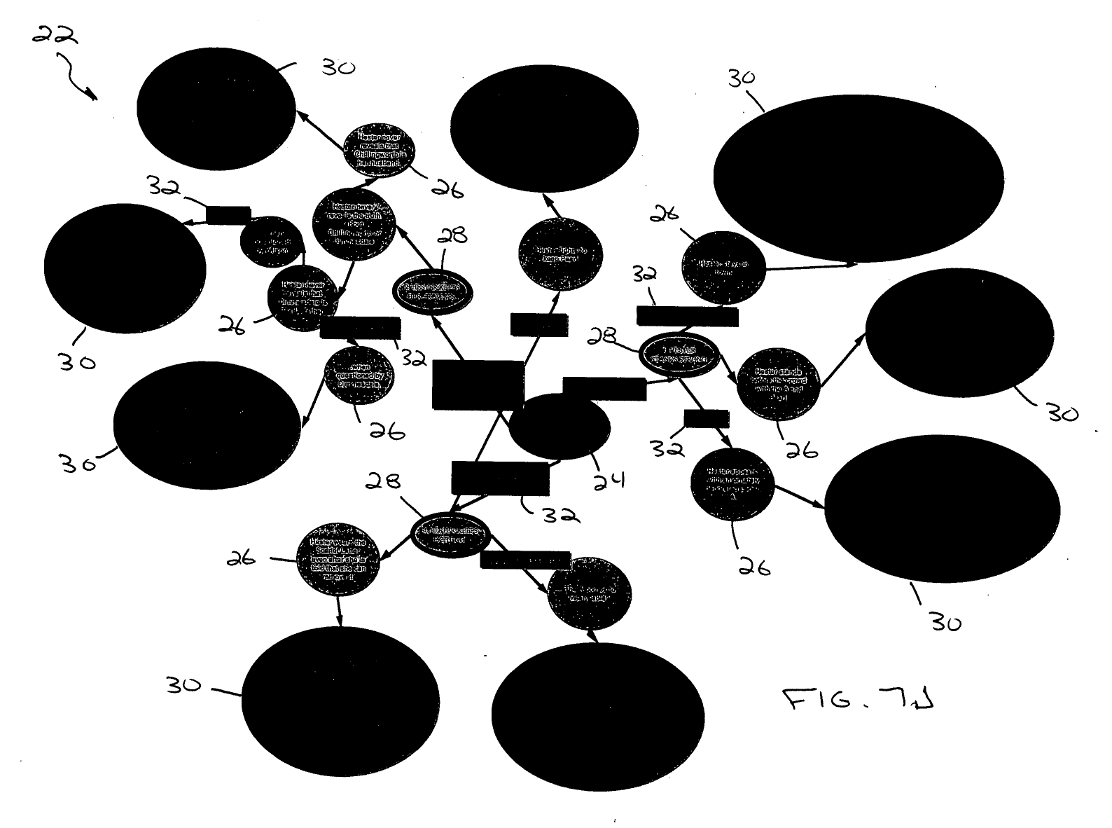

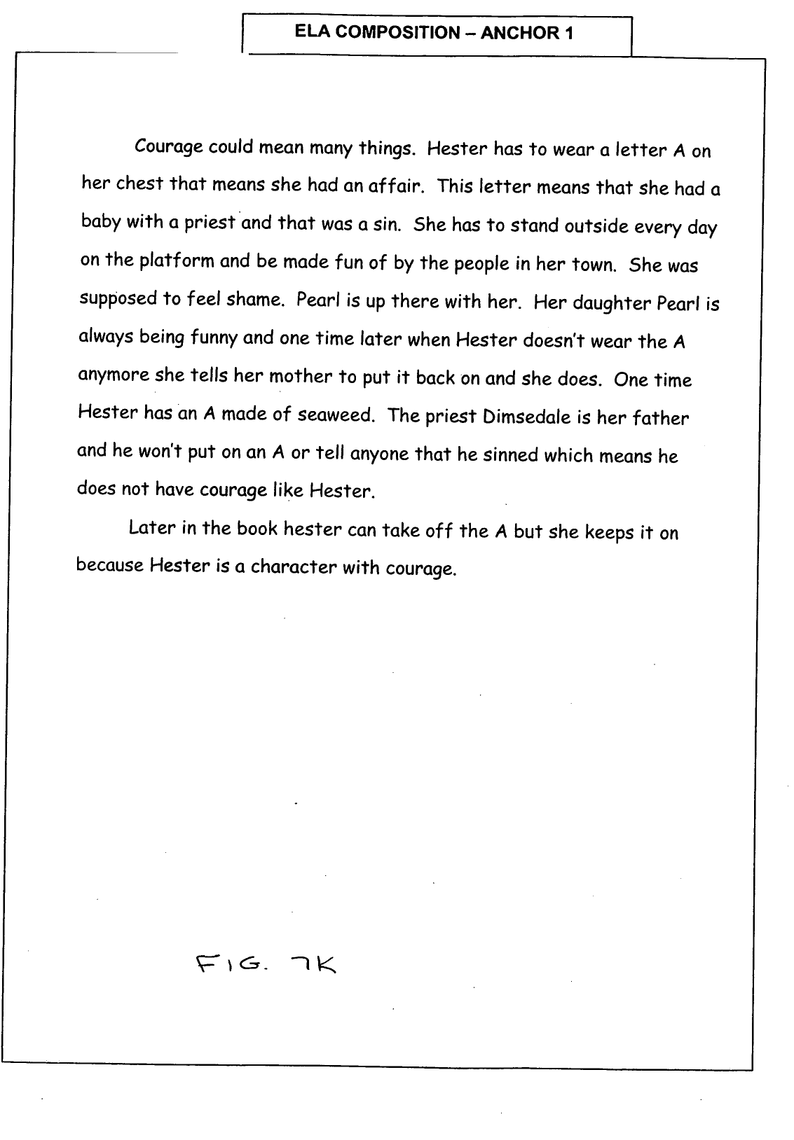

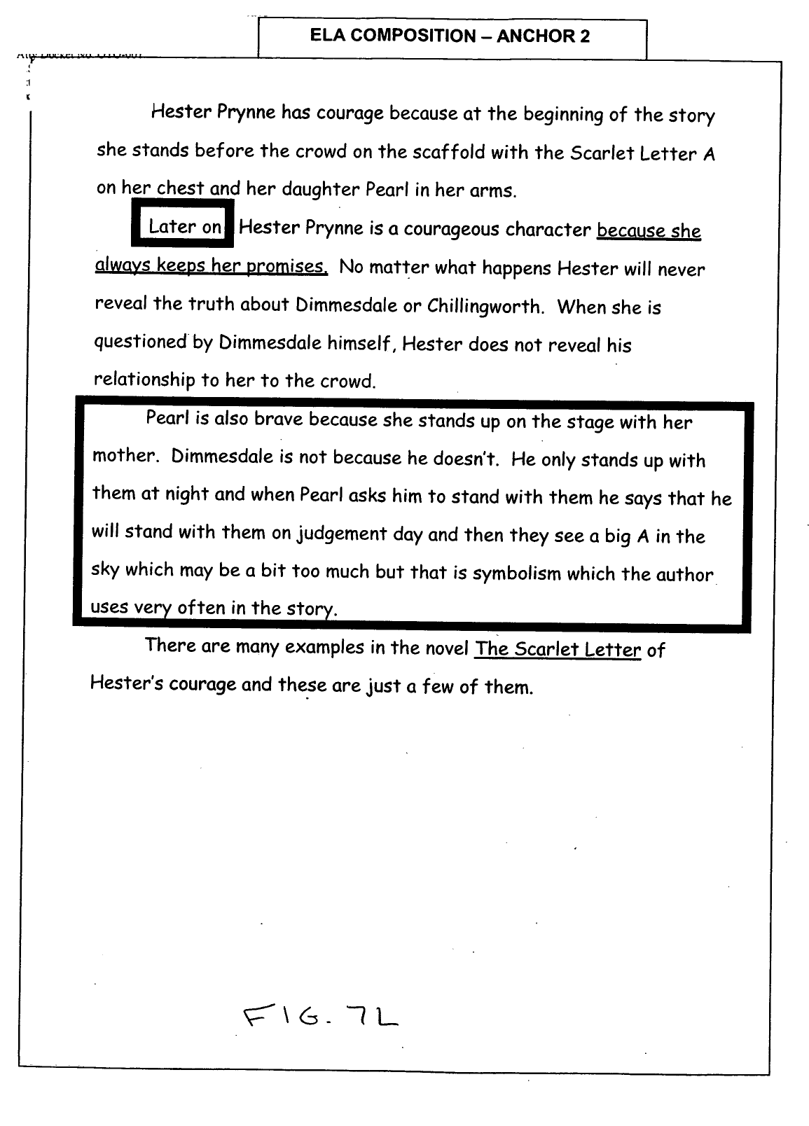

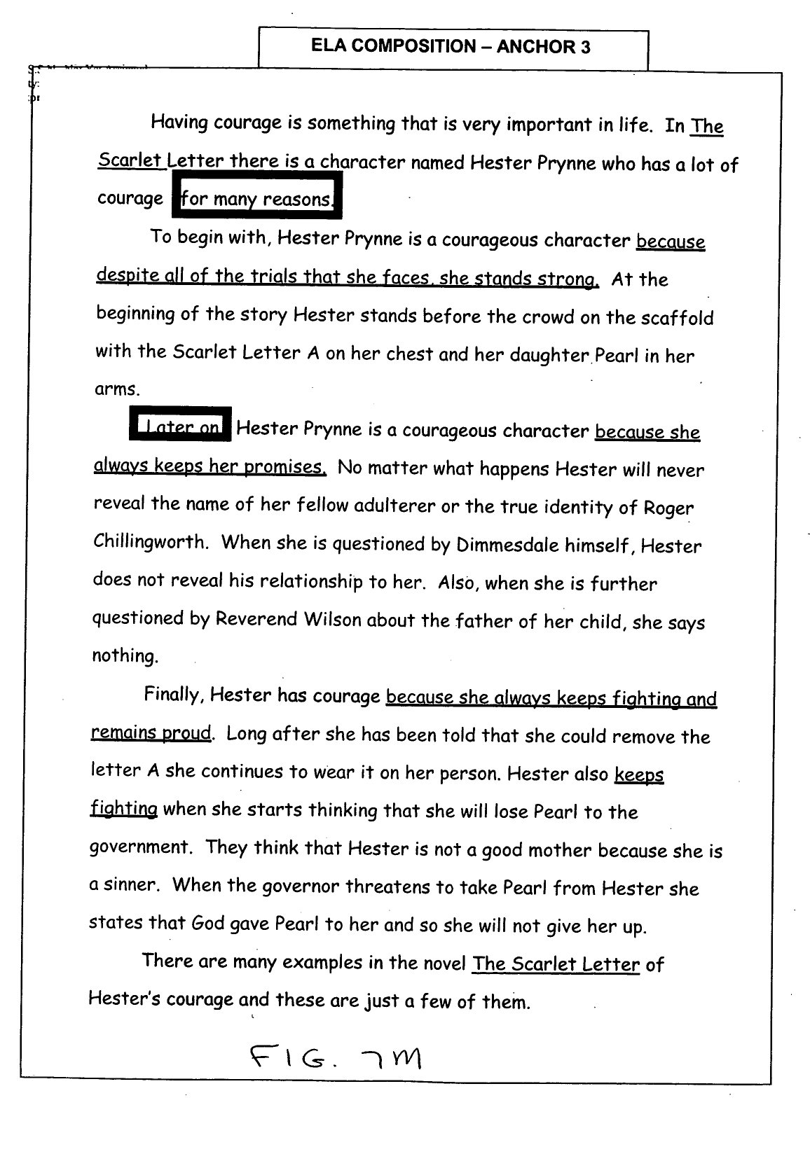

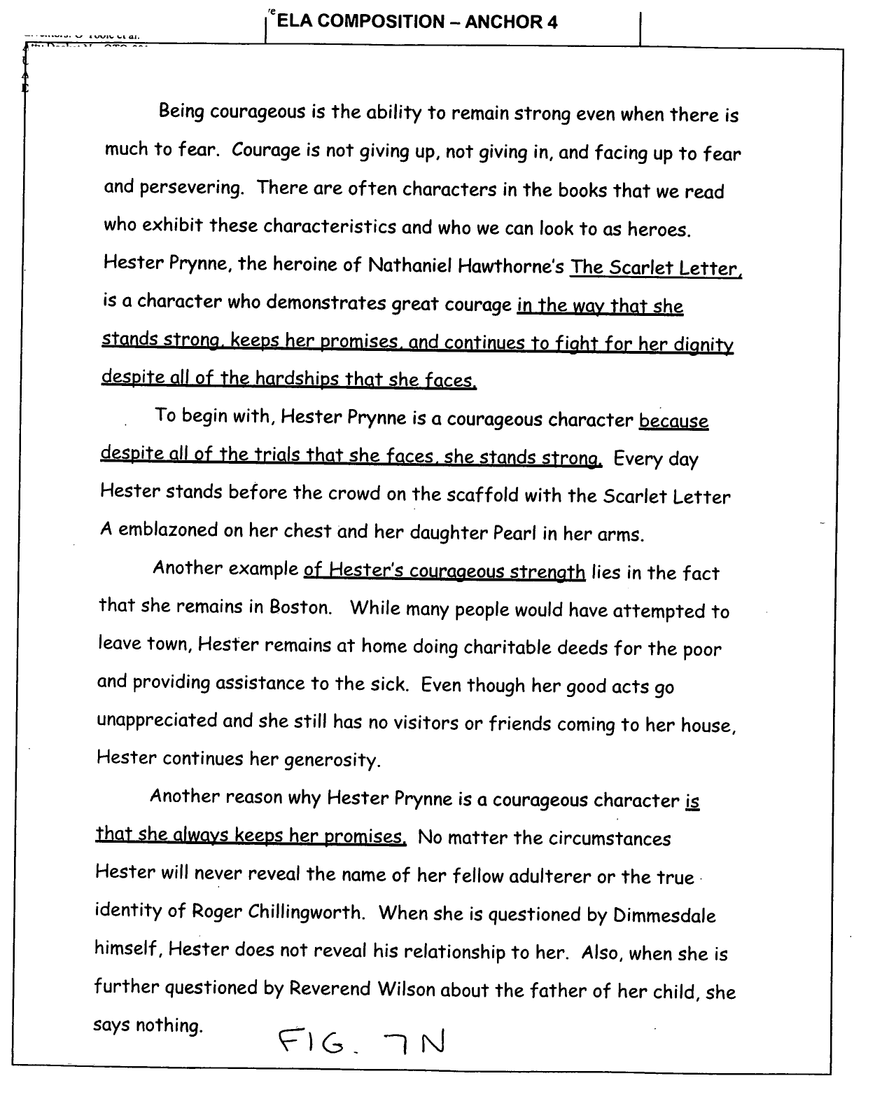

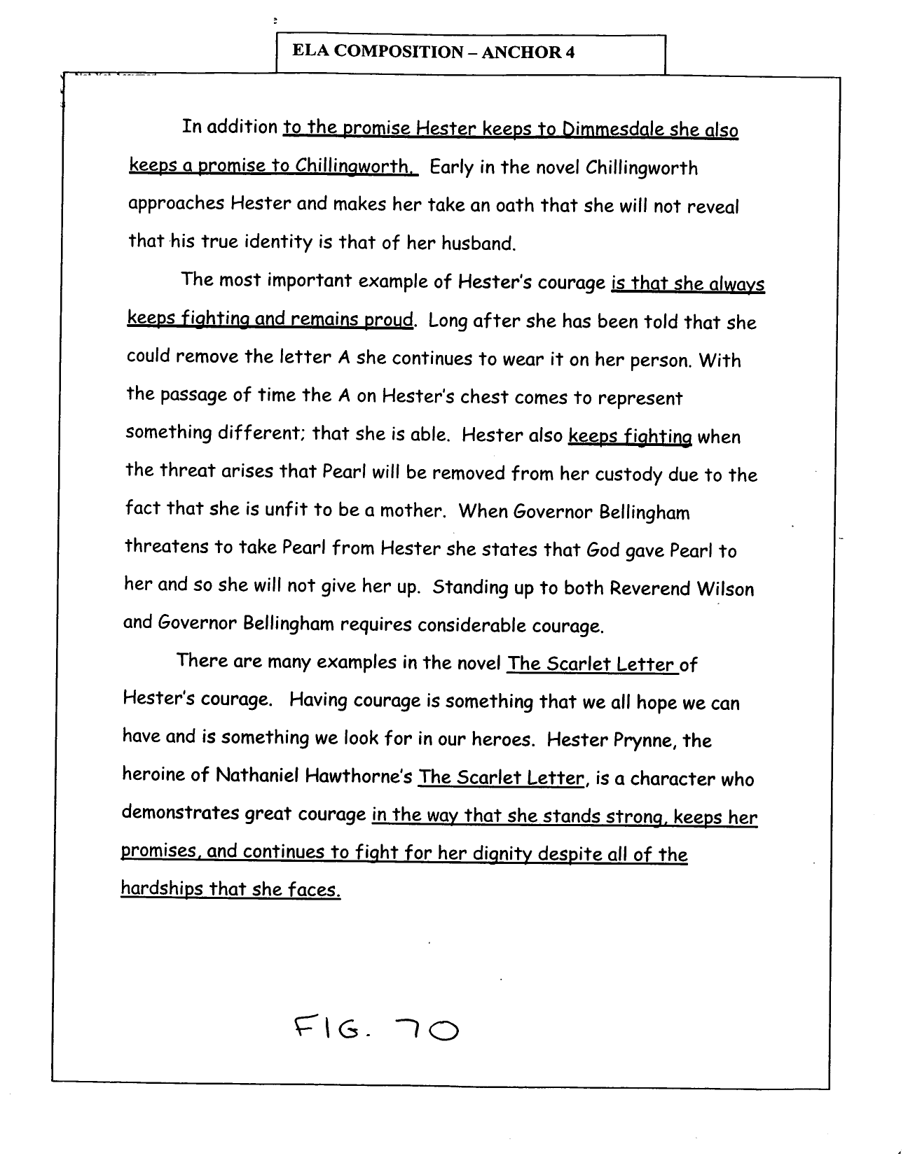

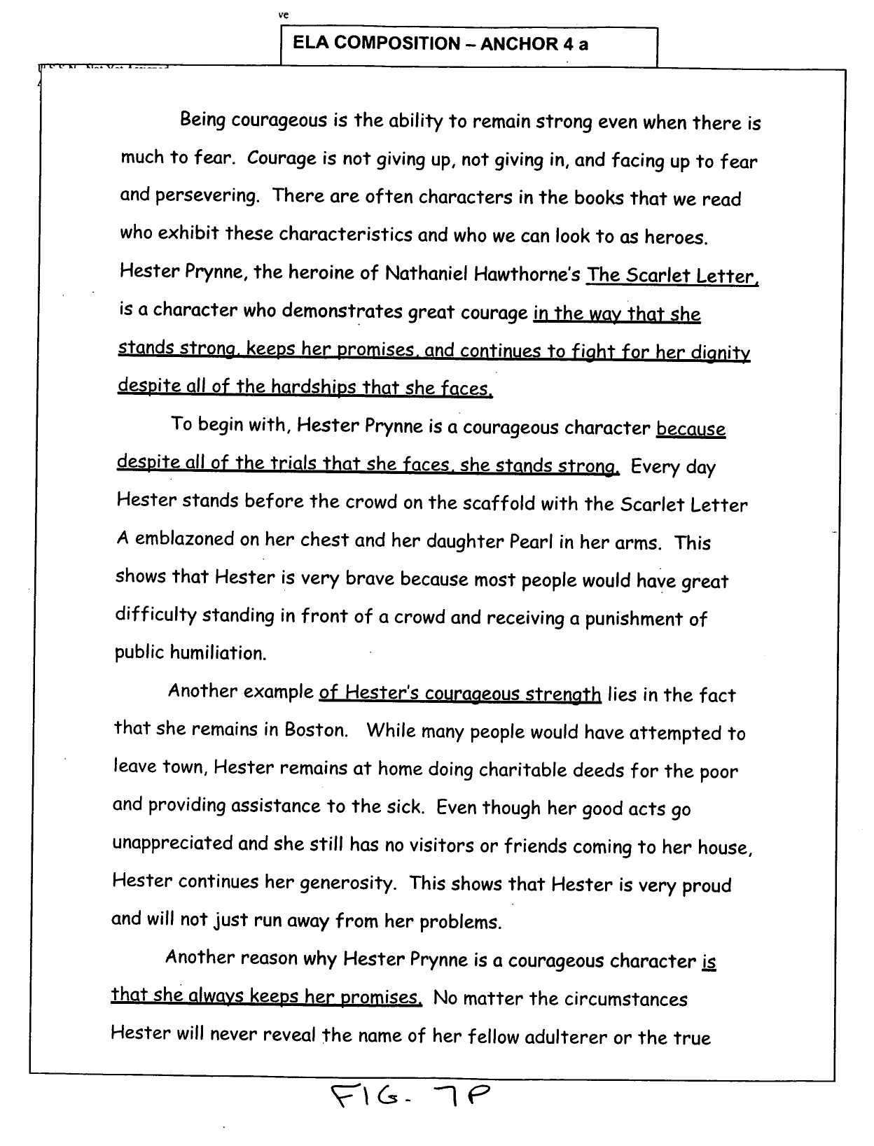

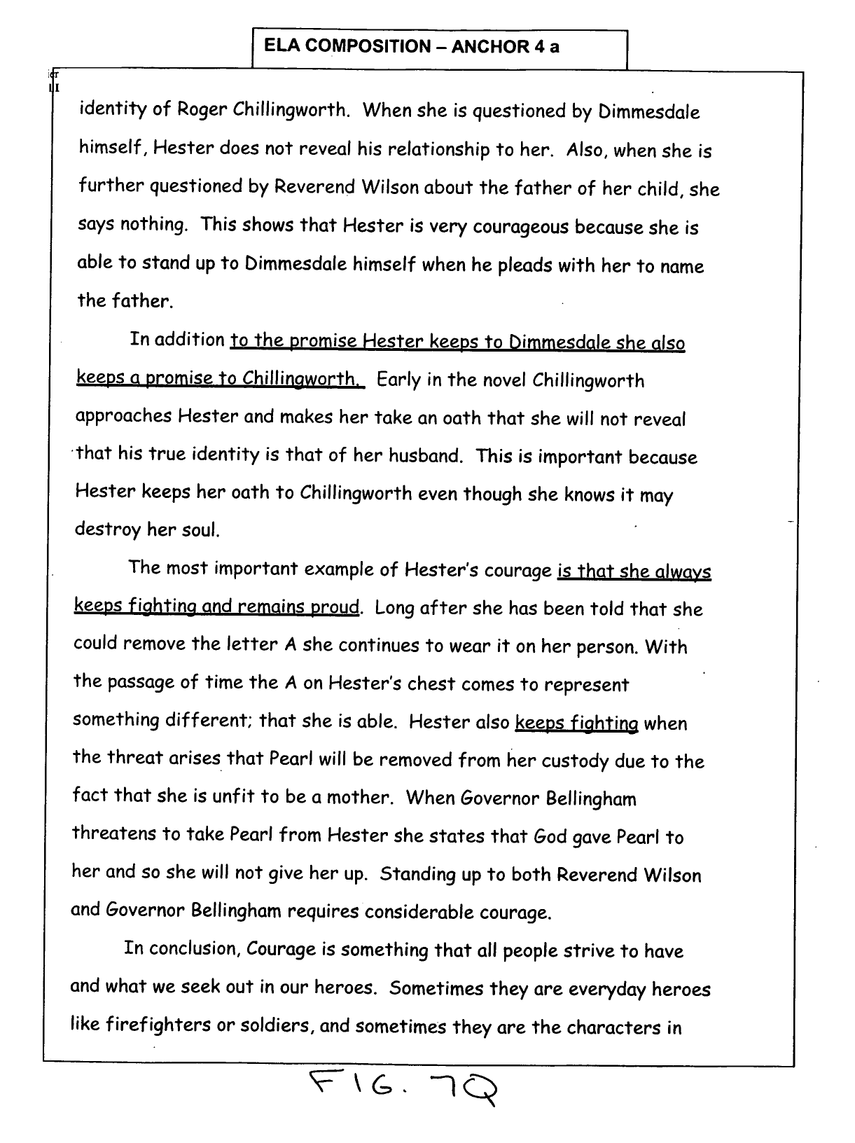

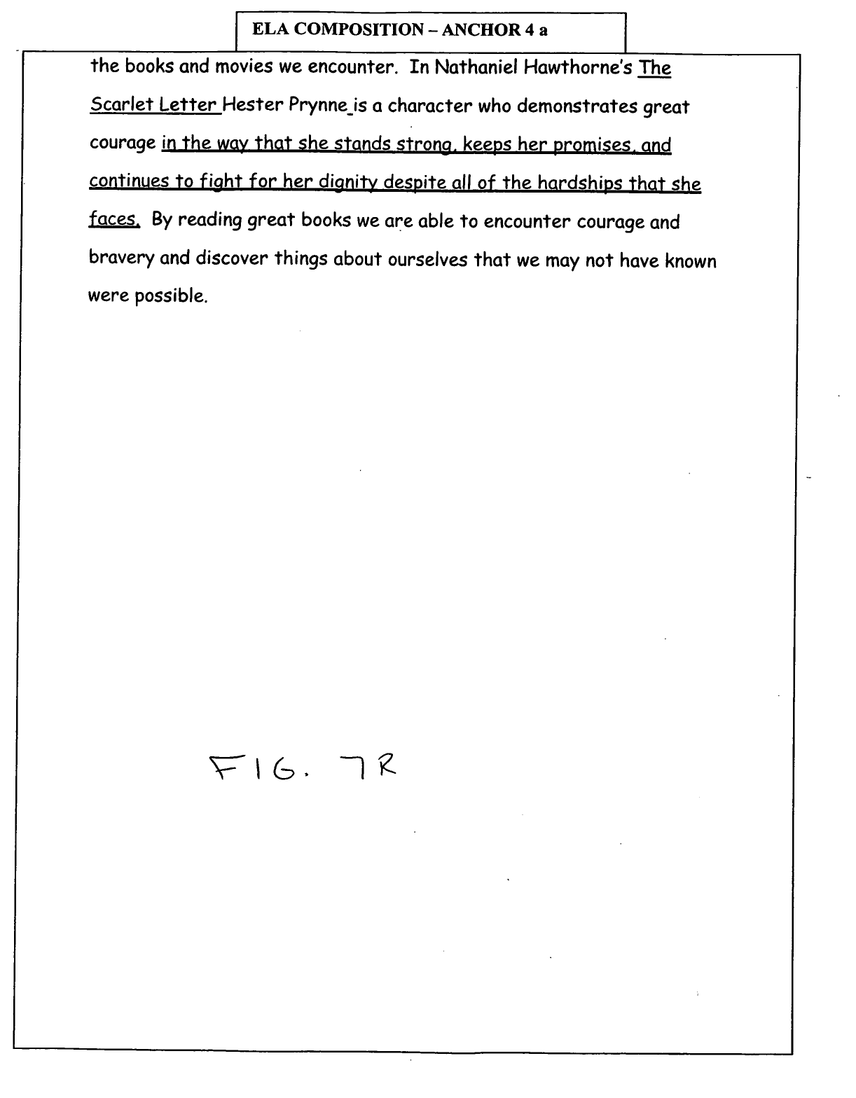

Students deconstruct the elements of all levels of writing from failing to advanced, first using colors matched to the key writing criteria associated with each exemplar, and then writing original compositions, using model colorized templates (see FIGS. 1-4 and 6) for the pre-writing stages, color-based criteria for teacher, peer, and self assessment, and finally producing an essay that is proficient or better.

The hands-on, colorful, interactive approach benefits all students with diverse learning styles. With this approach, students can clearly see the difference between a composition that meets the standard, exceeds the standard, and is below the standard. The approach also includes colorized exemplars to help all the students deconstruct what the standard is and templates to help to the students produce it themselves.

In one example of the method, the educator passes out pre-colored exemplars to the students. The exemplars may all relate to, for example, open responses of varying quality. By studying the pre-colored exemplars, the students are able to identify the key elements of an effective piece of writing, and at the same time are able to contrast the various exemplars to see what colored elements are present or missing from responses of varying quality. Next, the educator passes out uncolored exemplars that the educator and students collectively color and, thereby, identify the various writing elements. The educator may then pass out colorized templates that the students use to pre-write their responses. The students respond to the different colored prompts by filling in the appropriate writing elements. For example, a student completes a red prompt with a thesis statement and green prompts with details supporting the thesis statement. The templates may include additional colored prompts corresponding to transitional words or phrases, comments, or critical analysis.

Referring now to FIGS. 1-4, the sample templates 1 are web-type templates and include a thesis statement prompt 10 and supporting detail prompts 12 linked thereto (links 18). The user fills in the prompts as dictated by the associated colors. The colors are visual clues to the user as to what type of writing element is required and how it relates to the other writing elements. As shown in FIGS. 2 and 3, the user can link 18 and/or prioritize 16 the various supporting detail prompts 12 to further structure their written work. The template 1 shown in FIG. 4 includes commentary and analysis prompts 14 to further develop the written work. Any number of additional prompts can be added to the various templates 1 as needed. Once the template(s) are completed, the user incorporates the various elements into the completed written work.

FIG. 6 depicts an alternative template that is structured in paragraph form. By completing the colored prompts with the corresponding writing elements, the user creates a written work. In one embodiment, an educator can teach an entire class by creating the template on, for example, a whiteboard using colored pens.

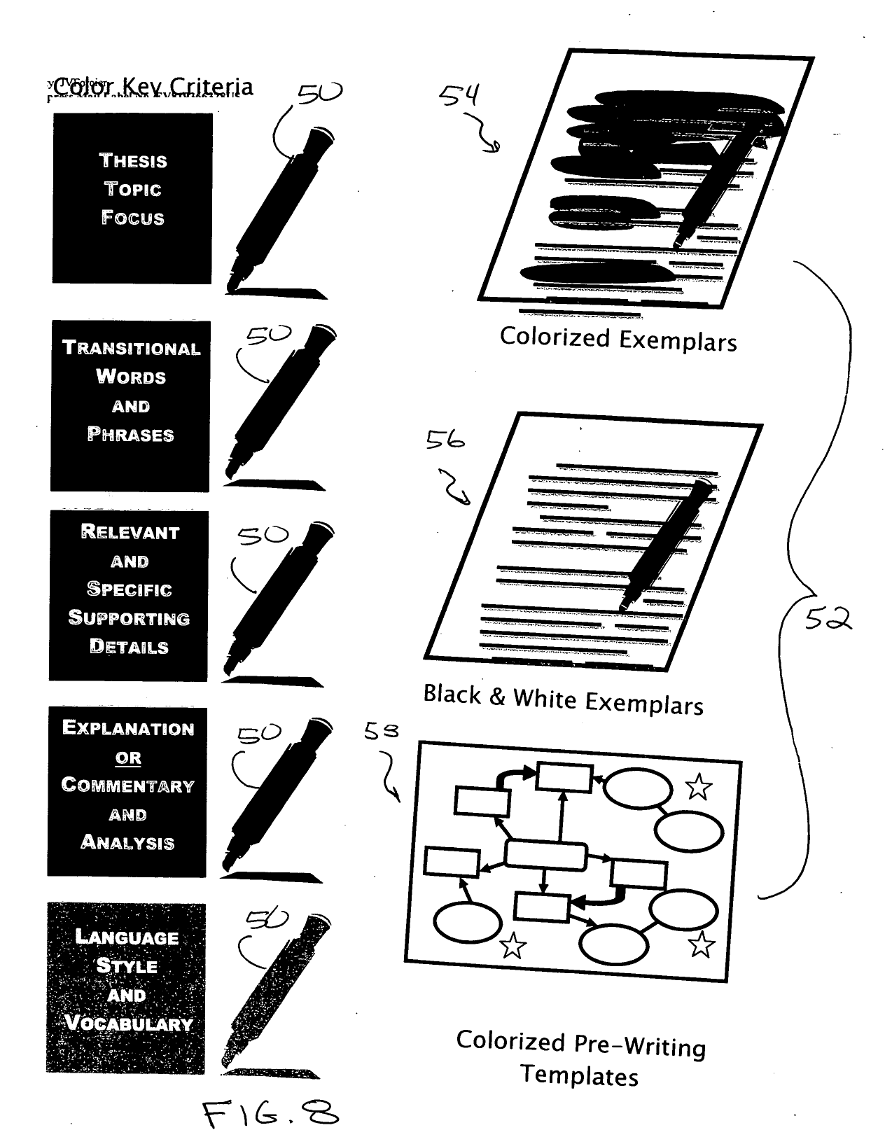

FIG. 8 depicts one example of a kit for guiding a user through a writing process. The kit includes at least one customized highlighter 50 corresponding to a specific writing element and a workbook 52. The workbook 52 includes at least one colorized exemplar 54, at least one black and white exemplar 56, and a colorized template 58 for completion by the user. In one embodiment, at least one pair of colorized and black and white exemplars and a corresponding colorized template are matched to a particular type of writing to be completed.

Having described certain embodiments of the invention, it will be apparent to those of ordinary skill in the art that other embodiments incorporating the concepts disclosed herein may be used without departing from the spirit and scope of the invention. The described embodiments are to be considered in all respects as only illustrative and not restrictive.

What is claimed is:

1. A method of teaching effective writing comprising the steps of:
matching a specific color to a specific writing element;
developing exemplars based on a student response; and
using colorized templates to guide the student through a writing process.

2. The method of claim 1, wherein the matching step further comprises matching a plurality of specific colors with a plurality of writing elements

3. The method of claim 2, wherein the plurality of writing elements comprise a thesis, transitional words and phrases, language, style, vocabulary, supporting details, and commentary and analysis.

4. The method of claim 1, wherein the step of developing exemplars are used to train a student to identify examples of effective and ineffective writing.

5. The method of claim 1, wherein the step of using colorized templates help a student to at least one of plan, assess, and revise their writing.

6. The method of claim 1 further comprising the step of transferring text from a completed template into a written work product.

7. The method of claim 1, wherein the step of developing exemplars comprises the steps of:
studying pre-colored exemplars; and
coloring uncolored exemplars to identify various writing elements.

8. The method of claim 1, wherein the step of using colorized templates comprises completing at least one prompt by filling in an appropriate writing element.

9. An apparatus for guiding a user through a writing process, the apparatus comprising:
a colorized template, the colorized template comprising:
a first user prompt having a first color corresponding to a first writing element; and
at least one second user prompt of a second color corresponding to a second writing element.

10. The apparatus of claim 9, wherein the template is a web-based template and the at least one second writing element builds off of the first writing element.

11. The apparatus of claim 9, wherein the first writing element is a thesis.

12. The apparatus of claim 11, wherein the at least one second writing element is a supporting detail for the thesis.

13. The apparatus of claim 9, wherein the template comprises multiple different writing elements that branch off each another.

14. The apparatus of claim 9, wherein the template is a paragraph-based template.

15. A kit for guiding a user through a writing process, the kit comprising:
at least one customized highlighter corresponding to a specific writing element; and
a workbook comprising:
at least one colorized exemplar;
at least one black and white exemplar; and
a colorized template for completion by the user, wherein at least one of the exemplars and a corresponding template are matched to a particular type of writing to be completed.
